(19) United States
(12) Patent Application Publication
(10) Pub. No.: US 2024/0323219 A1
(43) Pub. Date: Sep. 26, 2024

(54) SYSTEM, METHOD AND COMPUTER READABLE STORAGE MEDIUM FOR CONTROLLING SECURITY OF DATA AVAILABLE TO THIRD-PARTY PROVIDERS

(71) Applicant: NSAA Security Pty Ltd, Sydney (AU)

(72) Inventor: Ryan HAGH, Sydney (AU)

(73) Assignee: NSAA Security Pty Ltd, Sydney (AU)

(21) Appl. No.: 18/190,046

(22) Filed: Mar. 24, 2023

(51) Int. Cl. H04L 9/40

(52) U.S. Cl. CPC H04L 63/1433

(57) ABSTRACT

The disclosure relates to a method, system and computer readable storage medium for determining and/or controlling security of data available to a third-party provider. For example, the method controls security of data belonging to a client and available to a third-party provider by receiving vulnerability scan data, determining a plurality of vulnerability metrics for the data of the client at the third-party provider using the vulnerability scan data, wherein the plurality of vulnerability metrics are based on where the data belonging to the client is stored at the third-party provider, determining a security score for the third-party provider based on the plurality of vulnerability metrics and a risk profile of the client; and causing a display device to display the security score determined for the third-party provider to control security of the data belonging to the client and available to the third-party provider.

### TECHNICAL FIELD

The present invention relates generally to provision of information security and, in particular, to determining and/or controlling security of data at third-party providers. The present invention also relates to a system, method and computer readable storage medium for determining and/or controlling security of data belonging to a client and available to a third-party provider.

### BACKGROUND

Reference to background art or other prior art in this specification is not an admission that such background art or other prior art is common general knowledge in Australia or elsewhere.

Information technologies (IT) in general and software/hardware development in particular are becoming more widespread and cover various aspects of modern life from early childhood education to launching rockets into space. The stringent requirements relating to timeliness, security and scalability of modern IT solutions result in situations where some software/hardware components, which form a part of IT infrastructure of a given business, educational or government institution (e.g. a client), are developed by third-party providers (or vendors). Moreover, the third-party providers may store, e.g. have visibility and/or manage, data belonging to the client, often in a cloud.

Privacy legislation across the globe is becoming more concerned with information security of personal data as well and specifies penalties for inappropriate handling of personal information. Accordingly, to ensure security of data, businesses and other entities have to control security of data not only stored or processed at their end, but also ensure security of data processed, e.g. stored, managed and/or otherwise accessed, by the third-party providers.

For security reasons, third-party providers do not typically provide access to their infrastructure and/or system(s) to assess security of data managed by the third-party providers for vendor risk management (VRM) purposes. Existing solutions are typically based on a questionnaire prepared by the vendor's client and answered by a vendor's representative. Management of such questionnaires is often a manual process which cannot be performed in real time since such a process only reflects the procedures in place at the third-party provider, rather than the current state of security of data for a specific client.

Other solutions for VRM focus on collecting data about the vendor such as, certification, for risk management purposes. However, similar to the systems based on processing questionnaires, such an approach only provides information about the third-party provider in general, i.e. a static rating, rather than a current, real-time, state of security of data for a specific client.

Alternative approaches involve commissioning, by an interested body, i.e. a client, an external security scan for vulnerabilities within the infrastructure and/or systems owned by the third-party provider. In practice, however, such approaches may require an agreement between the third-party provider and a client as otherwise an external security scan may be illegal. Additionally, security scans require trained personnel capable to conduct a comprehensive external scan and/or assessment and, accordingly, result in significant resources and time. Keeping in mind that even a small entity may have 2-3 third-party providers, such an approach is often impractical. Moreover, external security scans, even if commissioned, are typically not conducted very often if at all especially by small to medium entities (SMEs). As such, external security scans are not capable of providing real-time information regarding the current state of security of data for a specific client for real time assessment of security of data belonging to the client and available to the third-party provider.

While third-party providers may arrange vulnerability scans for their own infrastructure and/or systems, vulnerability scan results typically contain sensitive information and, accordingly, are not shared with clients or other external parties for security reasons.

With a large number of vulnerabilities in third-party software and hardware products being discovered on a daily basis, there is a need to provide a system, method and computer readable storage medium for determining and/or controlling security of data belonging to a client and available to a third-party provider in real time.

### SUMMARY

It is an object of the present invention to substantially overcome, or at least ameliorate, one or more disadvantages of existing arrangements, or provide a useful alternative.

According to a one aspect of the present disclosure, there is provided a method of controlling security of data belonging to a client and available to a third-party provider, the method comprising: receiving vulnerability scan data; determining a plurality of vulnerability metrics for the data of the client at the third-party provider using the vulnerability scan data, wherein the plurality of vulnerability metrics are based on where the data belonging to the client is stored at the third-party provider; determining a security score for the third-party provider based on the plurality of vulnerability metrics and a risk profile of the client; and causing a display device to display the security score determined for the third-party provider to control security of the data belonging to the client and available to the third-party provider.

Receiving the vulnerability scan data may comprise parsing an internal vulnerability scan report generated by the third-party provider. The internal vulnerability scan may be performed for storage locations identified by the third-party provider as storing data belonging to the client. The plurality of vulnerability metrics may be selected based on where the data belonging to the client is stored at the third-party provider.

Receiving the vulnerability scan data may comprise accessing a container associated with the third-party vendor, the container comprising an indication of a location where internal vulnerability scan data related to the data of the client is stored. The container may be installed inside or outside a network of the third-party provider. The vulnerability scan data may identify the third-party provider.

The method may further comprise determining at least one first client of the third-party provider identified in the vulnerability scan data, wherein the plurality of vulnerability metrics are determined for the at least one first client. The method may further comprise determining at least one further client of the third-party provider identified in the vulnerability scan data, determining a plurality of vulnerability metrics for the data of the at least one further client at the third-party provider; and determining a security score for third-party provider with respect to the at least one further client based on the plurality of vulnerability metrics and a risk profile associated with the at least one further client, wherein the security score for the third-party provider with respect to the at least one further client is different to the security score for the third-party provider with respect to the at least one first client.

Determining a security score for the third-party provider may comprise: determining a value representing a number of risks in each of a plurality of risk categories based on the risk profile associated with the client and the plurality of vulnerability metrics; and determining the security score for the third-party provider based on the determined values, wherein each value represents a number of risks for a risk category in the plurality of risk categories. The method may further comprise determining a graphical representation of the security score based on a threshold to display on the display device.

The method may further comprise determining a plurality of third-party providers of the client by analysing internal data of the client and storing a correspondence between the client and the plurality of third-party providers in a database.

According to another aspect, there is provided a system for controlling security of data available to a third-party provider, the system comprising: a third-party provider module comprising a third-party provider processor and third-party provider memory storing instructions which when executed by the third-party provider processor cause the third-party provider processor to: provide an access to a location storing vulnerability scan data for a conducted internal vulnerability scan, the vulnerability scan data comprising a plurality of vulnerability metrics for the data of the client at the third-party provider, wherein the vulnerability scan data is based on where the data belonging to the client is stored at the third-party provider; a third-party risk assessment module communicatively coupled with the third-party module, the third-party risk assessment module comprising a processor and memory storing instructions which when executed by the processor cause the processor to: access the location storing the vulnerability scan data associated with the third-party provider; determining at least one client to which the vulnerability scan data pertains by accessing a database storing a correspondence between the at least one client and the third-party provider; determine a security score for the third-party provider based on the plurality of vulnerability metrics and a risk profile associated with the at least one client, wherein the plurality of vulnerability metrics is determined from the vulnerability scan data; and cause a display device to display the security score determined for the third-party provider.

Instruction for determining a security score for the third-party provider may comprise instructions for: determining a value representing a number of risks in each of a plurality of risk categories based on the risk profile associated with the client for the third-party provider and the plurality of vulnerability metrics; determining the security score for the third-party provider based on the determined values, wherein each value represents a number of risks for a risk category in the plurality of risk categories; and determining a graphical representation of the security score based on a threshold to display of the display device. The system may further comprise a client module, the client module comprising a client processor and client memory storing instructions which when executed by the client processor cause the client processor to determine a third-party provider involved with data of a client.

According to a further aspect, there is provided a computer readable storage medium for determining security of data belonging to a client and available to a third-party provider, the computer readable storage medium comprises computer readable instructions stored therein, the computer readable instructions being executable by a processor to cause the processor to: receive internal vulnerability scan data for at least a portion of infrastructure controlled by the third-party provider; determine a plurality of vulnerability metrics for the third-party provider from the received internal vulnerability scan data; and determine security of the data belonging to the client and available to the third-party provider based on the plurality of vulnerability metrics and a risk profile of the client.

Instructions for determining a security score for the third-party provider may comprise instructions for: determining a value representing a number of risks in each of a plurality of risk categories based on the risk profile associated with the client for the third-party provider and the plurality of vulnerability metrics; determining the security score for the third-party provider based on the determined values; and determining a graphical representation of the security score based on a threshold to display of the display device.

According to another aspect, there is provided a method of determining security of data belonging to a client and available to a third-party provider, the method comprising: receiving an internal vulnerability scan result for at least a portion of infrastructure controlled by the third-party provider; determining a plurality of vulnerability metrics for the third-party provider from the received internal vulnerability scan result; and determining security of the data belonging to the client and available to the third-party provider based on the plurality of vulnerability metrics and a risk profile of the client.

Other aspects are also disclosed.

### BRIEF DESCRIPTION OF THE DRAWINGS

Some aspects of at least one embodiment of the present invention will now be described with reference to the following drawings, in which:

FIGS. 1A and 1B form a schematic block diagram of a general purpose computer system upon which arrangements described can be practiced;

FIG. 2 shows a method performed by the third-party risk assessment module in accordance with one implementation of the present disclosure;

FIG. 3 shows a system for controlling security of data belonging to a client and available to a third-party provider in accordance with one implementation of the present disclosure;

FIG. 4 shows an example implementation of a Real-Time VRM of the system shown in FIG. 3;

FIG. 5 illustrates interaction between client, vendor and service manager VRM in accordance with one implementation of the present disclosure to provide a fully automated control of security of data available to the third party provider and belonging to the client;

FIG. 6 demonstrates possible relationships between clients and third party providers;

FIG. 7 shows a client application implementing a Real-Time VRM and an Intelligent Classic VRM in accordance with one implementation of the present disclosure;

FIG. 8 shows an overview of the Intelligent Classic VRM solution in accordance with one implementation of the present disclosure

FIG. 9 illustrates an extension to fourth, fifth, sixth, seventh, eighth etc. party providers in accordance with one implementation of the present disclosure;

FIG. 10 is a flow-chart of a method of determining a plurality of vulnerability metrics for the data of the client at the third-party provider in accordance with one implementation of the present disclosure;

FIG. 11 is a flowchart of a method of determining the risk rate in accordance with one implementation of the present disclosure;

FIG. 12 is a flowchart showing a method of determining risk rates count and corresponding categories based on the determined risk rate in accordance with one implementation of the present disclosure;

FIG. 13 is a flowchart showing a method of determining related risk categories and corresponding risk counts within each category in accordance with one implementation of the present disclosure;

FIG. 14 shows a flowchart of a method of determining a security score of a third party provider in accordance with one implementation of the present invention;

FIG. 15 shows a flowchart of a method of determining security score attributes based on the determined security score in accordance with one implementation of the present disclosure;

FIG. 16 shows an example interactive graphical user interface (GUI) providing real time risk assessment for a client A;

FIG. 17 shows visual rendering of security score as a pointer position in accordance with one implementation of the present disclosure;

FIG. 18 shows an example of output of the internal vulnerability scan in accordance with one implementation of the present disclosure;

FIGS. 19A, 19B, 19C and 19D shows example likelihood reference tables in accordance with one implementation of the present disclosure;

FIGS. 20A, 20B, 20C and 20D show example client consequence (impact) tables in accordance with one implementation of the present disclosure;

FIG. 21 shows example initial risk scores in accordance with one implementation of the present disclosure;

FIG. 22 shows example Maximum Risk Rate Scores in accordance with one implementation of the present disclosure;

FIG. 23 shows example Risk Weights in accordance with one implementation of the present disclosure;

FIG. 24 shows example thresholds for determining severity of security issues of the third party provider in accordance with one implementation of the present disclosure;

FIG. 25 shows an example of security score calculation in accordance with one implementation of the present disclosure;

FIG. 26 shows an example of getting CVSS information (in provider side) in accordance with one implementation of the present disclosure;

FIG. 27 shows an example of finding number of each risk from CVSS file (in server side) in accordance with one implementation of the present disclosure; and

FIG. 28 shows an example implementation of risk category procedure in accordance with one implementation of the present disclosure.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Some aspects of the present disclosure are intended to determine and/or control security of data belonging to a client and available to a third-party provider by providing a system, method and computer readable storage medium configured to obtain results of an internal vulnerability scan conducted by a third party provider and translate the results into a risk score based on a risk profile of a particular client. As such, two clients with different risk profiles would have different risk scores for the same third-party provider and from the same internal vulnerability scan.

According to some aspect of the present disclosure, the results of the internal vulnerability scan are not shared with the clients. Rather, the results of the internal vulnerability scan are parsed to determine vulnerability metrics, which are subsequently translated into risk rates and security scores specific to individual clients. Only risk rates and security scores are provided to the clients. As such, security of the third-party provider is not compromised.

According to some aspects of the present disclosure, the results of the internal vulnerability scan are stored in memory of a server based application only while determining risk rates for relevant clients. Once all risk rates for all clients are determined, the internal vulnerability scan report (or result) is deleted from memory to maintain privacy and security of the third-party provider.

In some implementations, the internal vulnerability scan report for a particular third-party provider is the same for all clients and different risk scores result from differences in risk profiles of the clients. For example, one client may indicate that vulnerabilities of the third-party provider have a severe impact on the client because the client shares with the third-party provider highly sensitive data. Another client, on the other hand, may only share non-sensitive data with the third-party provider and as such would indicate that vulnerabilities of the third-party provider have a moderate or low impact on that client.

Additionally, different clients may set up different tolerance with respect to likelihood of a particular vulnerability which again would result in different translation of the vulnerabilities identified in the internal vulnerability scan report to risk rates and risk scores.

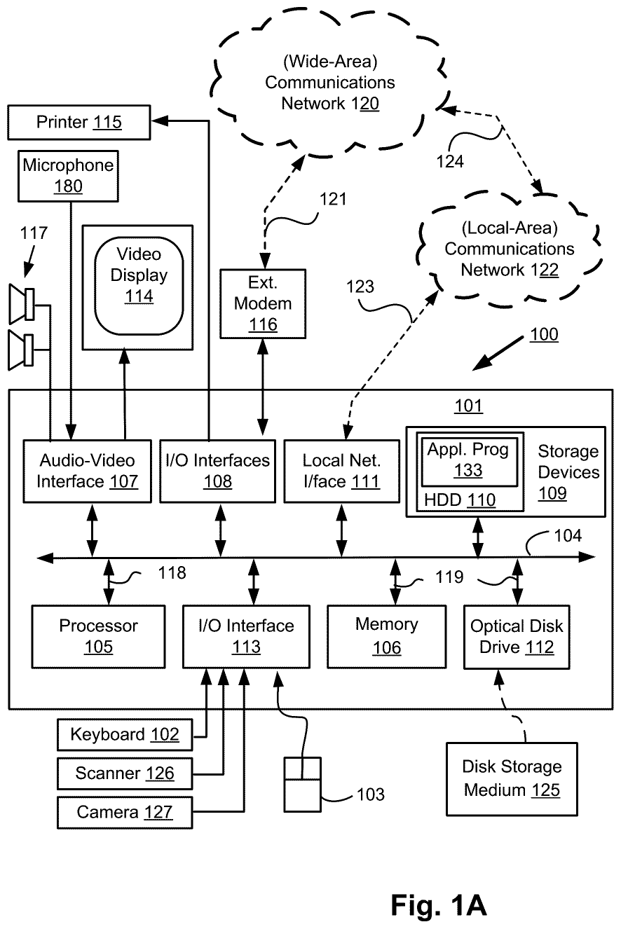

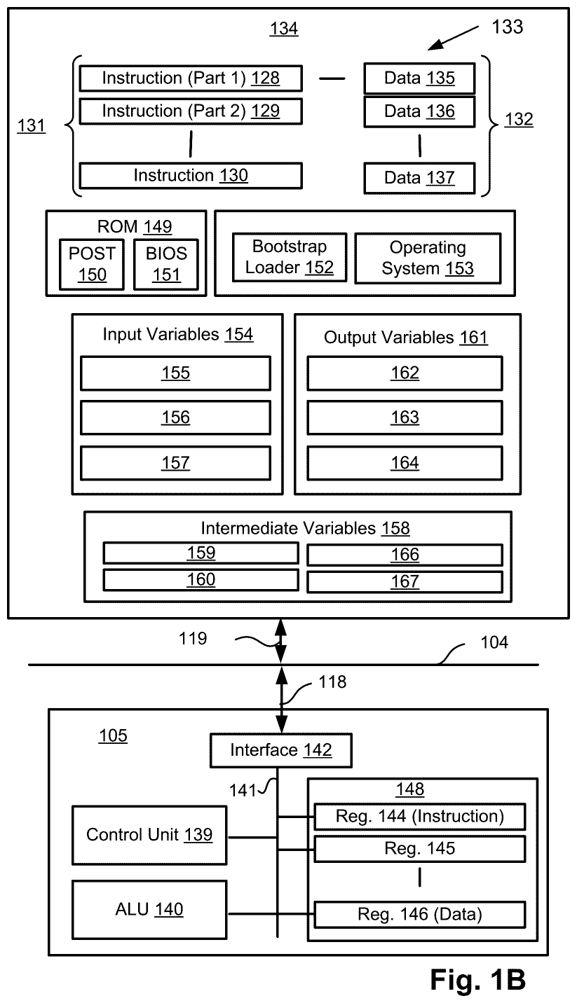

FIGS. 1A and 1B depict a general-purpose computer system 100, upon which the various arrangements described can be practiced.

As seen in FIG. 1A, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

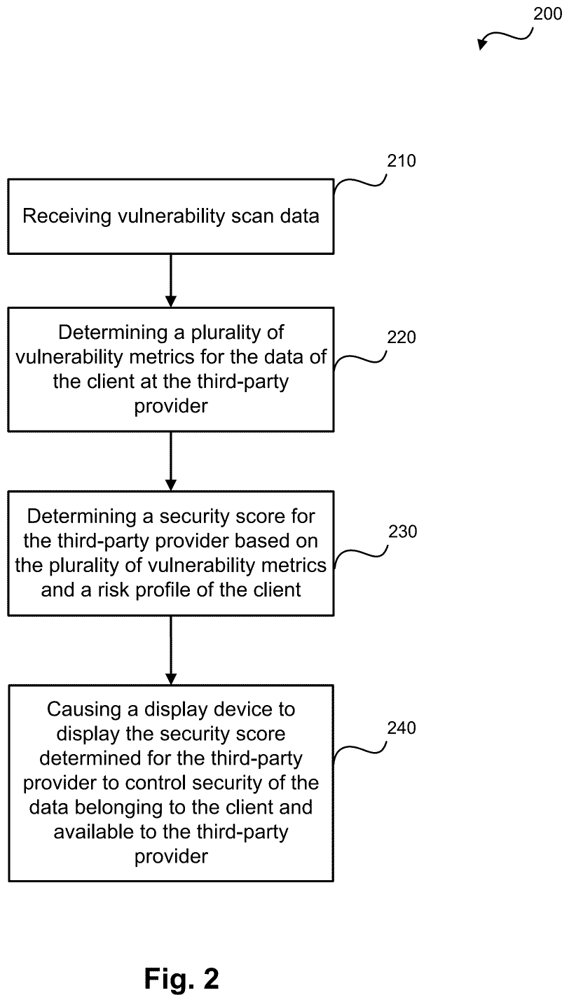

The method of controlling security of data available to a third-party provider may be implemented using the computer system 100 wherein the processes of FIGS. 2 to 15, to be described, may be implemented as one or more software application programs 133 executable within the computer system 100. In particular, the steps of the methods of FIGS. 2 and 10-15 are effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the methods of controlling security of data available to a third-party provider and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for controlling security of data available to a third-party provider.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for controlling security of data available to a third-party provider.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-Ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed arrangements for controlling security of data available to a third-party provider use input variables 154, which are stored in the memory 134 in corresponding memory locations 155, 156, 157. The arrangements for controlling security of data available to a third-party provider produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:
a fetch operation, which fetches or reads an instruction 131 from a memory location 128, 129, 130;
a decode operation in which the control unit 139 determines which instruction has been fetched; and
an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 2 to 18 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The method of controlling security of data available to a third-party provider may alternatively be implemented in dedicated hardware such as one or more integrated circuits performing the functions or sub functions of methods shown in FIGS. 2 and 10 to 15. Such dedicated hardware may include graphic processors, digital signal processors, or one or more microprocessors and associated memories.

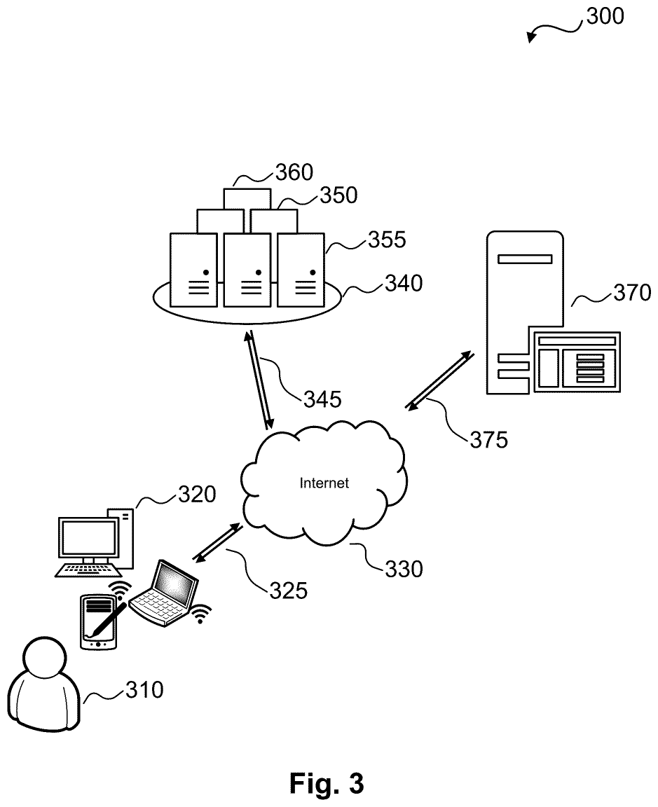

FIG. 3 schematically shows a system 300 for controlling security of data belonging to a client 310 and available to a third-party provider 340.

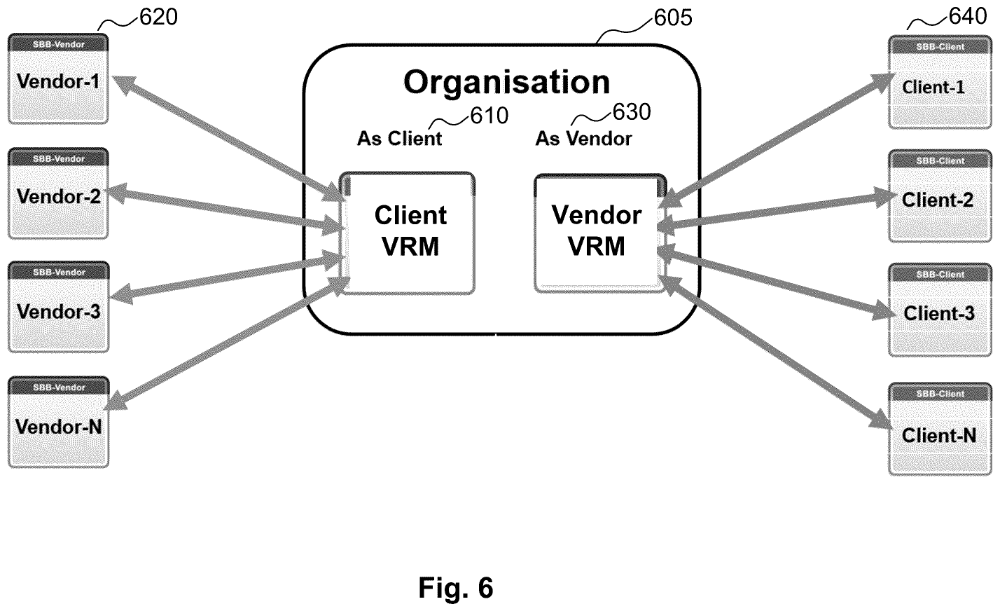

The client 310 is, for example, an entity which utilises products and/or services provided by the third-party provider (or vendor) 340 in the course of providing goods and/or services to other entities or end users. For example, an online shopping website may be considered to be a client of Amazon Web Services™, Microsoft™, Alphabet™ and a payroll and accounting system etc. As shown in FIG. 6, in some cases, an entity 605 can be considered as a client 610 with respect to a plurality of third-party providers (or vendors) 620 and as a third-party provider (or vendor) 630 with respect to a plurality of clients 640. In other words, while an organisation could be in a client-vendor relationship with their vendors, the same organisation could be a vendor for their own client and accordingly manage a vendor-client relationship with the client. As such, a single organisation could use both client and vendor modes of the disclosed vendor risk management (VRM) application at the same time.

For example, a payroll company may be a client of Amazon Web Services™ for managing cloud infrastructure and Microsoft™ for managing email communications while providing payroll services to a plurality of clients, which may also include Amazon Web Services™ and Microsoft™.

The client 310 has an IT infrastructure comprising a client device 320. The client device 320 may have a similar configuration to the computer system 100. Specifically, the client device 320 comprises a client processor, for example, a processor 105, and client memory, for example, memory 106, storing instructions for execution by the client processor 105.

The client device 320 runs a real-time VRM application or module, similar to the application program 133, executing instructions stored in memory 106.

In some implementations, the application program 133 executed on the client device 320 may be configured to analyse workflow of the client 310 during set up of the real-time VRM. The workflow may be analysed by accessing systems stored on the client 320 and/or in a client network to determine one or more third-party providers 340 involved with data of the client 310. A third-party provider is considered to be involved with the data of the client 310 if the third-party provider manages, processes, stores or otherwise has visibility of the data of the client 310.

For the purposes of the present disclosure, the term “store” with respect to data belonging to the client covers any storing of the data either in storage memory or working memory whether temporal or otherwise. Accordingly, the term “store” also covers situations where the third-party provider has visibility of the data of the client 310. As such, unless a contrary intention appears from the context, the term “store” is used to also include managing, processing and/or otherwise accessing the data belonging to the client since such operations typically involve at least reading of the data, i.e. loading data in working memory and/or registers of the processor. For brevity, the third party provider is considered to be involved with the data of the client if the data is “stored” at the third-party provider.

Once at least one third-party provider 340 involved with the data is determined, the application program 133 transmits a request, over a network 330 via connections 325 and 375, to a third-party risk assessment module or component to assess security of data belonging to the client and exposed, e.g. managed, processed, stored or otherwise visible, to the third-party provider 340. For the purposes of the present disclosure, the terms “module” and “component” can be used interchangeably.

The third-party risk assessment module can be implemented as an application program, for example application program 133, running on a processor, for example, the processor 105, of a server 370. The server 370 has similar configuration as the computer system 100.

The server 370 and, accordingly, the third-party risk assessment module are communicatively coupled with the client device 320 via the network 330 and wired or wireless connections 325 and 375. The third-party risk assessment module comprises instructions which when executed by the processor cause the processor to determine a security score for the third-party provider based on the plurality of vulnerability metrics and a risk profile associated with the client.

The request from the client device 320 to the third-party risk assessment module identifies the client 310 using a client identifier (“Client ID”) and the third-party provider 355 using a third-party provider identifier (“Vendor ID”) to the third-party risk assessment module. During the client set up and if the client has a real time VRM license, the third-party risk assessment module stores the Client ID in a database in association with one or more relevant Vendor ID(s).

In some implementations, the request is transmitted when the application program 133 of the client is initially set up, VRM license subscription is purchased and/or activated and/or when a new third-party provider of the client is determined. Upon receipt of the request, the third-party risk assessment module optionally creates a schedule for assessing risks associated with the third-party provider device 355.

In some implementations, the process of setting up a client also involves determining a client risk profile and storing the risk profile in a database of the third-party risk assessment module. The client risk profile comprises a default impact for a vendor (“default vendor impact”) as well as a risk rate for each combination of an impact and a likelihood of the vulnerability. The risk rates for each combination of the impact and the likelihood can be stored in a risk assessment matrix (RAM).

The default vendor impact is determined by the client and indicates what impact the third-party provider has on the client. The default vendor impact is typically based on category of data of the client stored at the third-party provider. In some arrangements, data is characterized by the client based on sensitivity. If a client engages different services of the same third-party provider, the client may set up the default vendor impact based on the highest level of sensitive data stored at the third-party provider. Alternatively, the client may set up a separate account for each service provided by the third-party provider and, accordingly, set up the default vendor impact based on sensitivity of data provided to each service. For example, if a client uses both JIRA™ and Confluence™ provided by Atlassian™, the client may set up one account for JIRA™ associated with a “Moderate” default vendor impact and other account for Confluence™ associated with a “Severe” default vendor impact.

The risk assessment matrix (RAM) specifies a risk rate for each combination of the vendor impact and a likelihood of vulnerability. In some implementations, the risk profile may also include likelihood type or count. However, the likelihood type can be determined from the RAM.

Once the client has been set up with the third-party risk assessment module, the client, in some implementations, sends a request to the third-party risk assessment module to assess risks associated with the third-party provider(s) of the client. In response to the request, the third-party risk assessment module adds the Client ID in association with Vendor ID to the database. Accordingly, when a new internal vulnerability report is received from the third-party provider, the third-party risk assessment module uses the Vendor ID indicated in the header of the report to identify the client and determine security of the data belonging to the client.

In some implementations, the third-party risk assessment module determines whether the client has a current real-time VRM license prior to storing a correspondence between the Client ID and the Vendor ID in the database. For example, the third-party risk assessment module may check license details in a database of the third-party risk assessment module based on the received Client ID. If the client does not have a current real-time VRM license, the third-party risk assessment module may issue a notification to that effect to the client and stop further processing.

In some arrangements, the third-party risk assessment module only determines security of the data belonging to the client when a real-time VRM license is active for the client 310. The service of determining security of data may be deactivated when the real-time VRM license expires, e.g. when the license in marked as inactive in the database for the Client ID.

The third-party provider 340 has an infrastructure comprising a network comprising servers 350, 360 and at least one third-party provider module or component running on one or more third-party provider devices 355. A server, for example, a server 350, and the third-party device 355 are communicatively coupled with the client device 320 and the third-party risk assessment module and has a configuration similar to the computer system 100. Specifically, the third-party device 355 comprises a third-party processor, for example, a processor 105, and third-party memory, for example, memory 106, storing instructions for execution by the third-processor 105.

The third-party provider module typically includes an application, similar to the application program 133, executing instructions stored in memory 106. The application program 133 executed on the third-party provider device 355 is configured to conduct an internal vulnerability scan. In some implementations, the internal vulnerability scan is conducted or run in accordance with the vulnerability scan schedule selected by the third-party provider. Alternatively, the internal vulnerability scan is conducted or run in response to a request from the third-party risk assessment module and/or in response to the request from the client 310, e.g. the client device 320, to assess security of the data belonging to the client 310. The internal vulnerability scan can be conducted using known tools, for example, Nmap™, Nessus™, Frontline™ etc.

For the purposes of the present disclosure, the term “internal vulnerability scan” refers to a vulnerability scan run by the third-party provider on infrastructure and/or systems owned and/or otherwise controlled by the third-party provider. In other words, the term “internal” refers to activities conducted internally with respect to the third-party provider. The term “internal” is used in contrast to activities run or conducted from outside of the infrastructure, e.g. networks, computers and/or servers, and/or systems owned and/or otherwise controlled by the third-party provider.

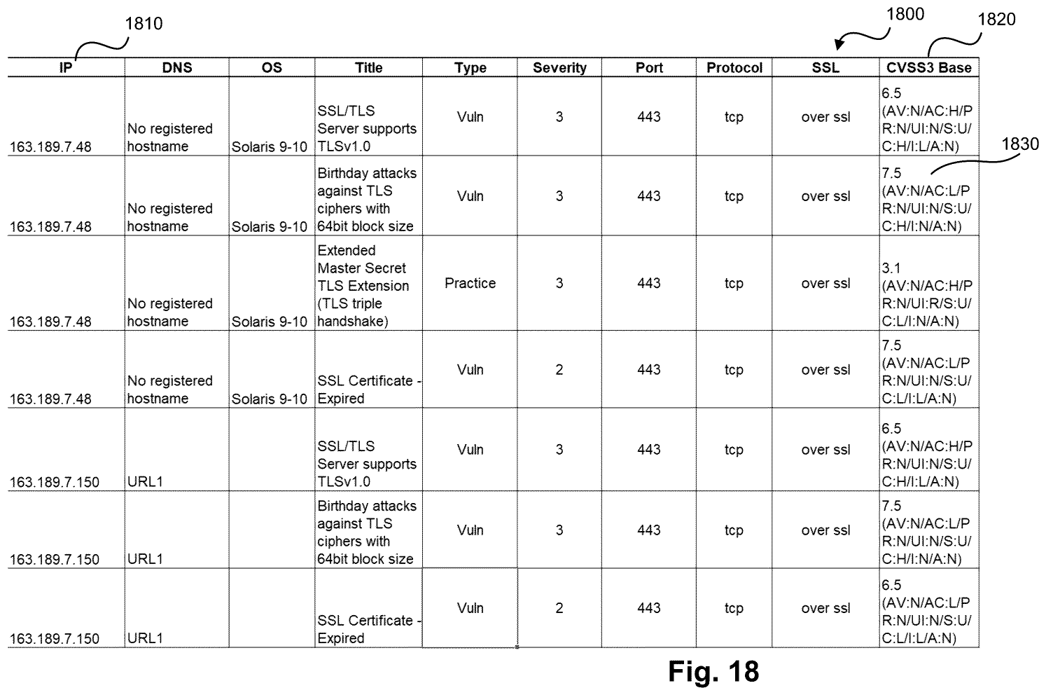

The output of the internal vulnerability scan is a vulnerability scan report comprising vulnerability scan data. The vulnerability scan data comprises a plurality of vulnerability metrics. An example output 1800 of the internal vulnerability scan is shown in FIG. 18.

As shown in FIG. 18, the output of the internal vulnerability scan can be is a form of a CSV file 1800. The CSV file 1800 includes a plurality of columns comprising at least an identifier of a scanned component 1810 and vulnerability metric values 1820 for the identified vulnerability of the scanned component 1810. If multiple vulnerabilities are identified for the scanned component, the CSV file includes a row for each vulnerability for each scanned component. In one implementation, the vulnerability metric value includes a Common Vulnerability Scoring System (CVSS) score and values of a plurality of vulnerability metrics.

In some implementations, the identifier of the scanned component 1810 can be in a form of an IP address of a scanned host. Alternatively, the identifier of the scanned component 1810 is an identifier of a segment of the network of the third-party provider, for example, an identifier of a sub-network.

The disclosed arrangements provide the capability to specify the vulnerability result at the server level, i.e. specifically identify server(s) where data belonging to the client is stored, managed, accessed or otherwise processed. Some implementations, however, specify the vulnerability result at a network segment level by the third-party provider, e.g. by specifically identifying sub-networks or network segments where data belonging to the client is stored, managed, accessed or otherwise processed. Arrangements specifying the vulnerability result at a network segment level are typically more efficient and less complex. In some implementation, the third-party provider has flexibility of managing internal vulnerability scans to generate vulnerability scan data for the Real-Time VRM result for the client. For example, the third-party provider is able to determine whether to specify the result at a network segment level or at a server level.

On completion or during execution of the internal vulnerability scan, the application program 133 running on the third-party processor 105 stores vulnerability scan data. In some implementations, the vulnerability scan data is specific to the client. The vulnerability scan data comprises a plurality of vulnerability metrics for the data of the client at the third-party provider. The vulnerability scan data specific to the client is determined based on where the data belonging to the client is stored at the third-party provider.

In some implementations, the internal vulnerability scan is performed for storage locations identified by the third-party provider as storing data belonging to the client identified in the request. As such, only vulnerability metrics relevant to the data of the client are included in the vulnerability scan data specific for the client. For example, the third-party provider 340 can determine that only server 350 stores the data of the client 310. As such, only server 350 may be scanned for vulnerabilities. In some arrangements, the third-party provider 340 can determine that only a certain sub-network of the third-party provider 340 stores the data of the client 310. As such, only the determined sub-network may be scanned for vulnerabilities.

Alternatively, the internal vulnerability scan is conducted across the entire network of the third-party provider 340. If the internal vulnerability scan is conducted across the entire network of the third-party provider 340, the third-party risk assessment module selects only vulnerability metrics based on where the data belonging to the client is stored at the third-party provider. For example, if a particular vulnerability metric is related to the server 360 which does not store, process or have access to the data of the client 310, such a vulnerability metric is not considered relevant and is not included for assessing security of data belonging to the client 310. If, however, a particular vulnerability metric is related to the server 350 where data of the client 310 is stored, such a metric is included for assessing security of data belonging to the client 310.

In some situations, however, vulnerabilities detected in the server 360 are so significant that they compromise the entire network of the third-party provider 340. Accordingly, in some implementations, vulnerabilities detected at the server 360 which may affect security of the entire network of the third-party provider may be included in the vulnerability scan data specific for the client even though the server 350 does not necessarily have the same vulnerability. For example, if an attacker may gain control over the entire network of the third-party provider through a vulnerability at the server 360, such a vulnerability is included in the vulnerability scan data specific for the client.

Since vulnerability metrics are determined based on where the data belonging to the client is stored, a value of at least one of the plurality of vulnerability metrics for the data for one client would differ from a value of a corresponding at least one the plurality of vulnerability metrics for the data for another client. Accordingly, the same third-party provider may have different security scores determined for two different clients.

In some implementations, the same vulnerability identified by the third-party provider may result in two different risks and security scores for two different clients since the impact of that vulnerability is (or might be) different for the businesses of the two different clients. Additionally, different clients may have different tolerance to likelihood of a particular vulnerability. For example, as discussed below, some arrangements of the present disclosure identify the Likelihood and Impact of the risk to calculate a risk rate. The risk rate is determined based on the Risk Assessment Matrix (RAM) of the client to determine a security score. The RAM specifies a risk rate determined by the client for each combination of impact of a vulnerability and a likelihood of the vulnerability.

As such, even if the same vulnerability has the same Likelihood, but two different clients have two different data classifications involved, the vulnerability will have different impacts on businesses of such clients. In some implementations, data is typically classified by the client based on a level of sensitivity of data shared with a particular third-party provider. Classification of data based on the level of sensitivity of the data shared with the third-party provider as reflected in a default vendor impact. The default vendor impact can be, for example, “Catastrophic”, “Severe”, “Moderate” and “Low”. For example, if data shared with the third-party provider is highly sensitive, the client may set the default vendor impact as “Severe” or “Catastrophic”. Accordingly, the same vulnerability will result in different risk rates. As a result, the third-party provider will have a different security score for different clients.

In response to determining the vulnerability scan data, the application program 133 running on the third-party processor 105 provides an access to the location where the vulnerability scan data is stored to a third-party risk assessment module. For example, an address or an indication of the location can be stored in a container provided by the third-party vendor to the third-party risk assessment module. The container can be installed inside or outside a network of the third-party provider 340. Alternatively, the access to the location can be provided by sending an IP address of the location to the third-party risk assessment module. Additionally, access may require appropriate permissions, for example, to read the vulnerability scan data.

The third-party risk assessment module comprises instructions which when executed by the processor cause the processor to access the location storing the vulnerability scan data and determine a security score for the third-party provider based on the plurality of vulnerability metrics and a risk profile associated with the client.

In some implementations, the third-party risk assessment module accesses the container provided by the third-party vendor, which comprises an indication of the location where internal vulnerability scan data related to the data of the client is stored. In some implementations, the container is designated for the client or a group of clients subscribed to the same service of the third-party provider.

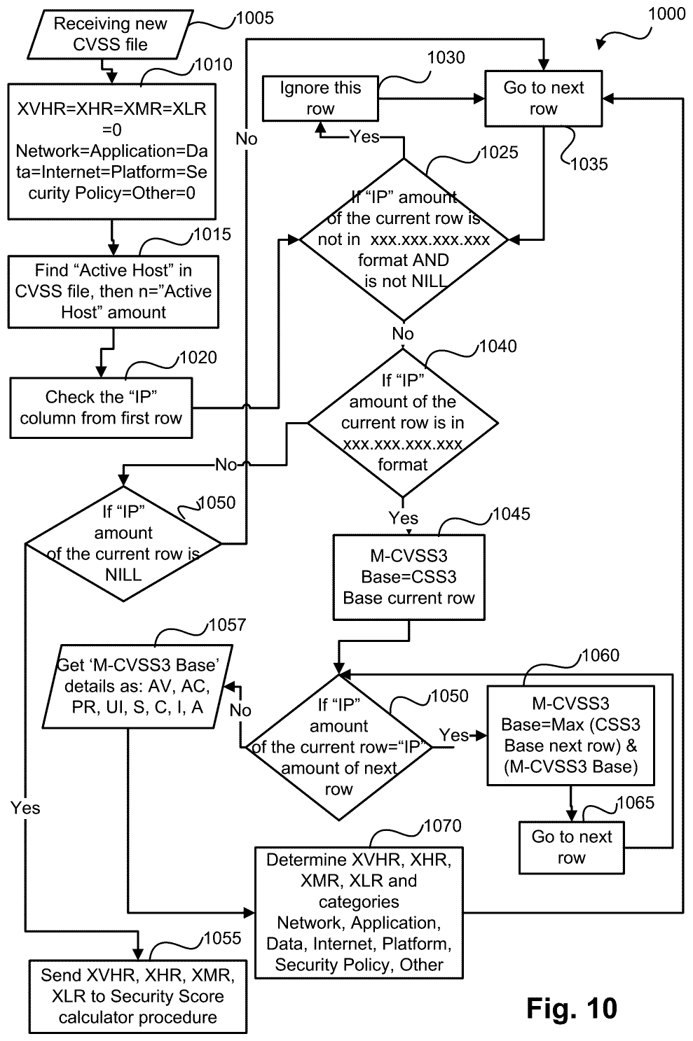

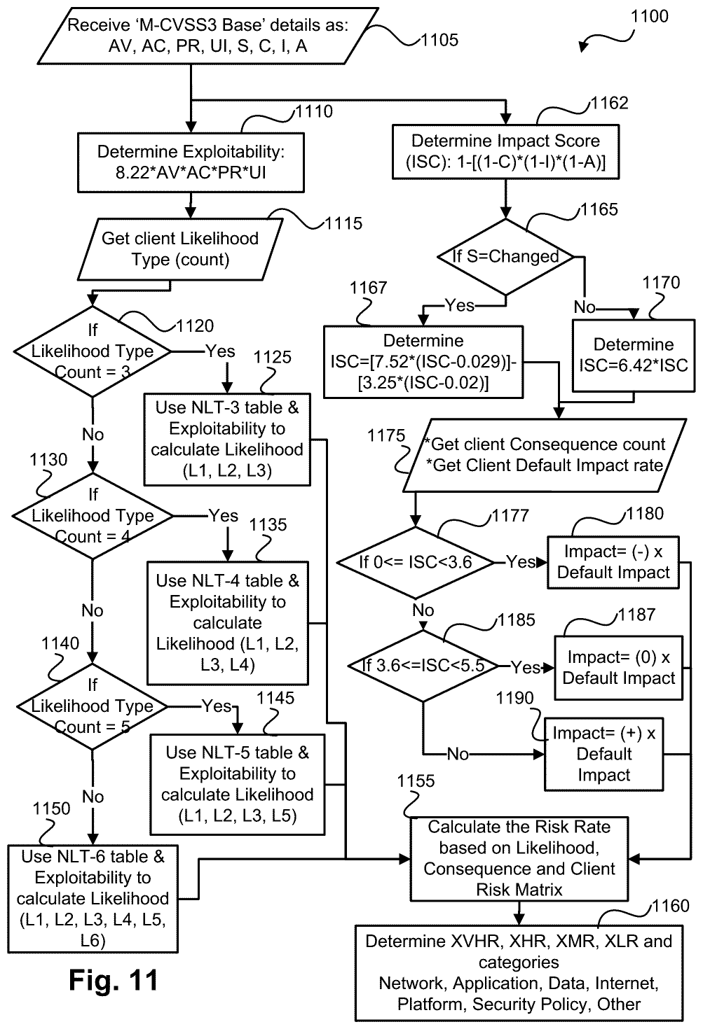

In some implementations, accessing the vulnerability scan data may involve parsing the vulnerability scan data, for example, as discussed with references to FIG. 10. The process of determining the security score for the third-party provider based on the plurality of vulnerability metrics and a risk profile associated with the client is discussed in more detail with reference to FIGS. 11 to 14.

In response to determining the security score for the third-party provider, the third-party risk assessment module of the server 370 proceeds to causing a display device to display the security score determined for the third-party provider 340. For example, the third-party risk assessment module of the server 370 may cause a display device of the client device 320 to display a colour coded security score determined for the third-party provider 340. The process of determining a colour for the determined security score is discussed in more detail with reference to FIG. 15.

In some implementations, the third-party risk assessment module provides real-time assessment of security of data at third-party providers when a new vulnerability scan report is available.

Alternatively, the third-party risk assessment module may receive and/or generate a request to assess security of data belonging to the client at one or more third-party providers. The request accordingly can be associated with a plurality of third-party providers comprising a first third-party provider and a second third-party provider. For example, the client device 320 may request the third-party risk assessment module to conduct risk assessment for all third-party providers of the client 310. In this situation, the third-party risk assessment module would generate requests for each third-party provider of the client, e.g. a first third-party provider device and a second third-party provider device, to assess security of data belonging to the client.

In some implementations, the third-party risk assessment module may query DataCollector(s) (discussed in more detail below) associated with the first third-party provider and the second third-party provider to get an up to date vulnerability scan report for each of the first and second third-party providers.

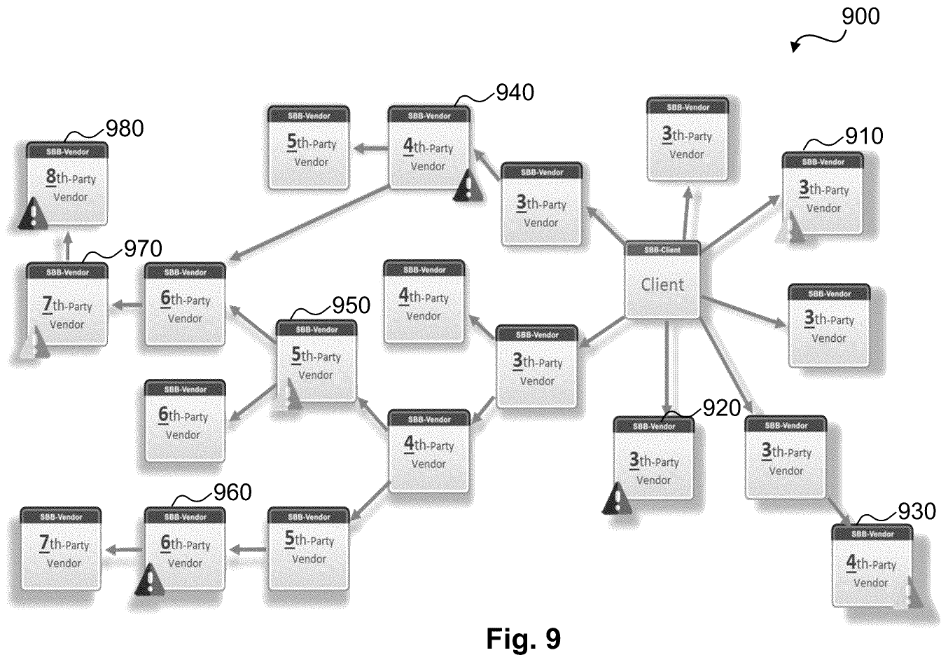

Alternatively, the third-party risk assessment module may cause the first third-party provider device, e.g. a provider 910 shown in FIG. 9, and the second third-party provider device, e.g. a provider 920 shown in FIG. 9, to conduct internal vulnerability scans directly by sending instructions to each of the third-party provider devices 355, over the network 330, specifying the client.

The third-party risk assessment module may instead access predetermined locations within the infrastructure of the third-party providers 910 and 920 where relevant vulnerability scan reports prepared by the third-party providers 910 and 920 are stored. For example, the third-party risk assessment module may access containers for each of the third-party providers 910 and 920 and control the DataCollector to fetch vulnerability scan data from locations indicated in the containers.

The internal vulnerability scan at the first third-party provider 910 results in a first plurality of vulnerability metrics for data belonging to the client and available at the first third-party provider 910. The internal vulnerability scan at the second third-party provider 920 results in a second plurality of vulnerability metrics for data belonging to the client and available at the second third-party provider 920. The third-party risk assessment module can determine a first security score for the first third-party provider 910 based on the first plurality of vulnerability metrics and a risk profile associated with the client for the first third-party provider 910. The third-party risk assessment module can determine a second security score for the second third-party provider 920 based on the second plurality of vulnerability metrics and a risk profile associated with the client for the second third-party provider 920. The third-party risk assessment module can cause a display device of the client to display the first security score and the second security score either sequentially or simultaneously, for example, as shown in FIG. 9 discussed in more detail below.

FIG. 2 shows a method 200 performed by the third-party risk assessment module in accordance with one implementation of the present disclosure in more detail. The method 200 runs on a processor 105 of the server 370 under control of instructions stored in memory 106.

The method 200 commences at a step 210 of receiving vulnerability scan data. In some implementations, the vulnerability scan data in an internal vulnerability scan report.

The vulnerability scan data may be received in response to a request to assess security of data belonging to a client, for example, the client 310. The request is associated with a third-party provider. For example, the request may specify or comprise data indicating the client which requires the assessment and data indicating one or more third-party providers which need to be assessed. As discussed above, the request may be associated with a plurality of third-party providers. The request may originate from the client. Alternatively, the request may originate from a component of the third-party risk assessment module.

For example, the request may be an initial request when a client is set up with the third-party risk assessment module. When the client is set up with the third-party risk assessment module, the request comprises the Client ID and identification of the third-party provider, for example, a Vendor ID, if the third-party exists in the database of the third-party risk assessment module.

Alternatively, the vulnerability scan data may be received in response to a Data Collector application determining that a new vulnerability scan report is available at a particular third-party provider.

If the request is triggered by a new vulnerability scan report available at the third-party provider, the request identifies the third-party provider by the Vendor ID specified in a header and/or file name of the vulnerability scan report. The third-party risk assessment module determines one or more clients to which the report is relevant, for example, by looking up ClientIDs based on the identification Vendor ID of the third party provider in the database of the third-party risk assessment module.

Additionally, third-party risk assessment module may determine one or more clients to which the report is relevant based on which hosts and/or sub-networks of the third-party provider were scanned as part of the vulnerability scan report and whether data of specific clients is stored in the scanned hosts and/or sub-networks. The association between the Client ID, Vendor ID and locations within the infrastructure of the third-party provider relevant to the client, e.g. hosts and/or sub-networks, may be stored in the database of the third-party risk assessment module. The location may be determined based on services provided by the third-party provider to the client. For example, if the third-party provider provides several software as a service (Saas) products and the client only uses some of such products, only hosts and/or sub-networks where products used by the client are run are considered as relevant locations.

The method 200 proceeds from step 210 to a step 220 of determining a plurality of vulnerability metrics for the data of the client at the third-party provider. Step 220 may involve parsing of the vulnerability scan data as discussed with reference to FIG. 10 to determine the plurality of vulnerability metrics.

The plurality of vulnerability metrics is determined based on where the data belonging to the client is stored at the third-party provider. For example, the method 200 may access vulnerability scan data specific to the client prepared by a third-party provider, for example, the provider 340.

As discussed above, the internal vulnerability scan may be performed by the third-party provider exclusively for storage locations and/or sub-networks identified by the third-party provider as storing data belonging to the client identified in the request. Alternatively, the internal vulnerability scan could be conducted by the third-party provider across the entire network of the third-party provider 340. The third-party risk assessment module may determines vulnerability metrics relevant to the client based on where the data belonging to the client is stored at the third-party provider.

As discussed above, locations within the infrastructure of the third-party provider where client data is stored can be determined based on services provided by the third-party provider to the client. For example, if the third-party provider provides several software as a service (SaaS) products and the client only uses some of such products, only hosts and/or sub-networks where products used by the client are run are considered as relevant locations. As such, only rows corresponding to the relevant hosts and/or sub-networks are selected for determining vulnerability metrics relevant to the client.

Accordingly, only vulnerability metrics relevant to the data of the client are included in the vulnerability scan data specific for the client. In other words, the plurality of vulnerability metrics is determined based on where the data belonging to the client is stored at the third-party provider. In some implementations, all vulnerability metrics from the vulnerability scan data are used to determine the plurality of vulnerability metrics and assess security of data belonging to the client and stored at the third-party provider.

Step 220 continues to a step 230 of determining a security score for the third-party provider based on the plurality of vulnerability metrics and a risk profile of the client. The risk profile of the client is dependent on which data the client shares with the third-party provider, e.g. which data of the client the third-party provider stores, and impact such data has on the client. For example, the client may determine an impact for sensitive data involved with the third-party provider (“default vendor impact”) as “Catastrophic”, “Major”, “Moderate” or “Minor”. In some implementations, the risk profile specifies a default vendor impact for each vendor and a risk rate for each combination of the impact for the client and likelihood of the vulnerability. The risk rate for each value of the impact and likelihood may be stored in a Risk Assessment Matrix (RAM). Example RAMs are shown in Tables 1 and 2.

For example, Client-1 and Client-2 may have the same vulnerability from the same third-party provider. Client-1, however, has sensitive data involved with the third-party provider. Accordingly, the default vendor impact for the third-party for Client-1 may be ‘Major’ compared to ‘Minor’ for Client-2.

An example Risk Assessment Matrix for Client 1 is shown in Table 1.

TABLE 1
Example Risk Assessment Matrix for Client 1

| | Impact (Consequence) | | | |
|---|---|---|---|---|
| | C1 - | C2 - | C3 - | C4 - |
| Likelihood | Catastrophic | Major | Moderate | Minor |
| L1 - Almost | Very High | Very High | Very High | High |
| Certain | | | | |
| L2 - Very Likely | Very High | High | High | High |
| L3 - Likely | Very High | High | Medium | Medium |
| L4 - Unlikely | Medium | Medium | Low | Low |
| L5 - Very | Medium | Low | Low | Low |
| unlikely | | | | |

An example Risk Assessment Matrix for Client 2 is shown below in Table 2.

TABLE 2
Example Risk Assessment Matrix for Client 2

| | Impact (Consequence) | | |
|---|---|---|---|
| Likelihood | C1 - Severe | C2 - Moderate | C2 - Minor |
| L 1 - Almost | Very High | Very High | High |
| Certain | | | |
| L2 - Very Likely | Very High | High | Medium |
| L3 - Likely | High | Medium | Medium |
| L4 - Unlikely | Medium | Low | Low |
| L5 - Very | Low | Low | Low |
| unlikely | | | |

As discussed above, the Client-1 may have determined that the business impact related to the sensitive data involved with the third-party provider is “Major” during set up of the real-time VRM with the third-party risk assessment module.

If the likelihood of the vulnerability to which both Client 1 and Client 2 are susceptible at the third-party provider is determined as ‘Likely’, the risk based on the above RAM shown in Table 1 for Client 1 would be ‘High’. However, for Client-2, who have non-sensitive data involved with the third-party provider, the impact of such a vulnerability would be ‘Minor’ as shown in Table 2 of the RAM stored for Client 2. As such, the risk calculated for Client-2 for the same vulnerability at the third-party provider would be “Medium” as highlighted in Table 2.

Accordingly, for the same vulnerability for the same third-party provider, two clients may have the same likelihood for the risk, but different impacts and different RAMs as per their respective risk profiles. As a result, such clients would have different Risk Rate counts and Security Scores. For instance, the Security Score of the third-party provider for Client-1 might be 63%, while the Security Score of the third-party provider for Client-2 might be 87% while the vulnerability might be the same.

In some implementations, the process of determining the security score for the third-party provider comprises determining a value representing a number of risks for each of a plurality of risk rates or categories based on the risk profile associated with the client and the plurality of vulnerability metrics. For example, each risk can be categorised or rated as a very high risk (VHR), high risk (HR), moderate risk (MR) or low risk (LR). Rating of risks is dependent on the client risk profile as well as assessment of vulnerability metrics. For example, accessibility of payroll data may be categorised as a very high risk for an accounting firm while for others the same vulnerability metric may carry a low risk as discussed above. Categorisation of risks is explained in more detail with references to FIGS. 11 to 13.

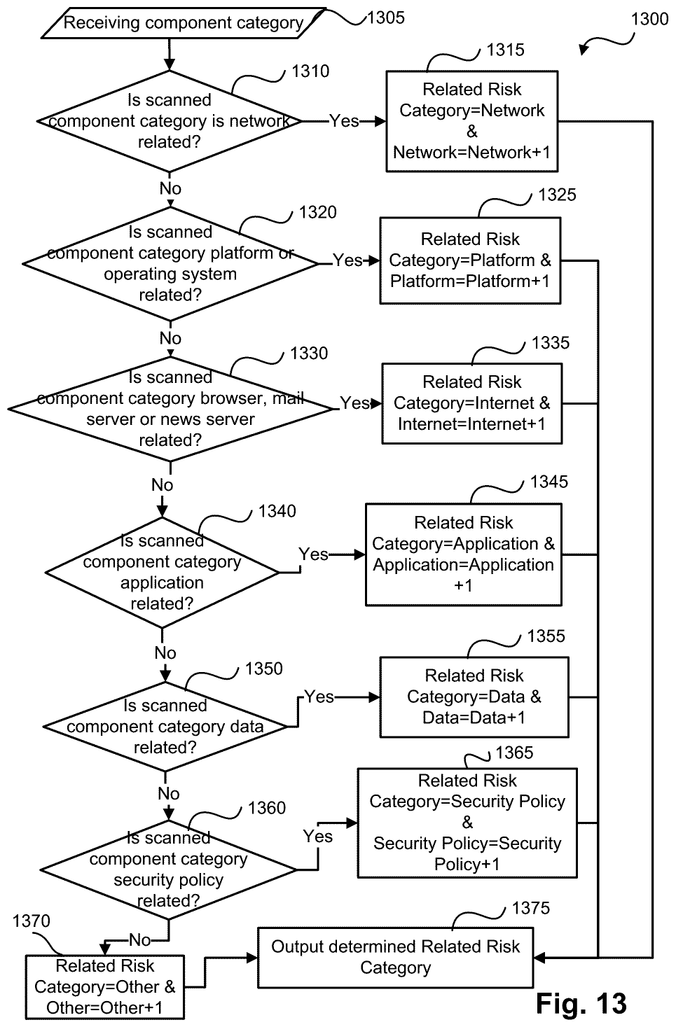

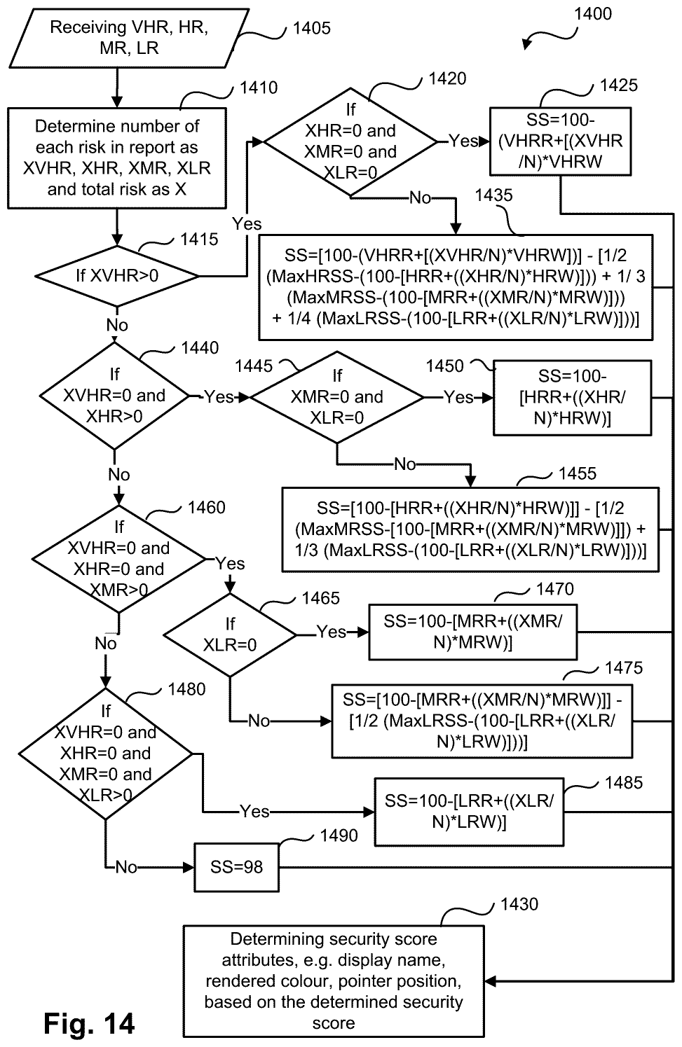

Once the number of risks in each category is determined, the method 200 at step 230 determines the security score for the third-party provider based on the determined values, wherein each value represents a number of risks for a risk category in the plurality of risk categories. The process of determining the security score is described in more detail with references to FIG. 14.

If there are multiple clients for the third-party provider associated with the vulnerability scan data received at step 210, steps 220 and 230 are performed for each of the client in parallel or sequentially.

The method 200 proceeds from step 230 to a step 240 of causing a display device to display the security score determined for the third-party provider to control security of the data belonging to the client and available to the third-party provider. In some implementations, the display device displays the security scores for all third-party providers simultaneously. Alternatively, the security score can be displayed separately for each third-party provider in a separate user interface. In some implementations, one merged report is generated to cover all vendor providers.

The method 200 may determine a graphical representation of the security score at step 240 based on a threshold. The graphical representation of the security score can be determined, for example, as discussed with references to FIG. 15.

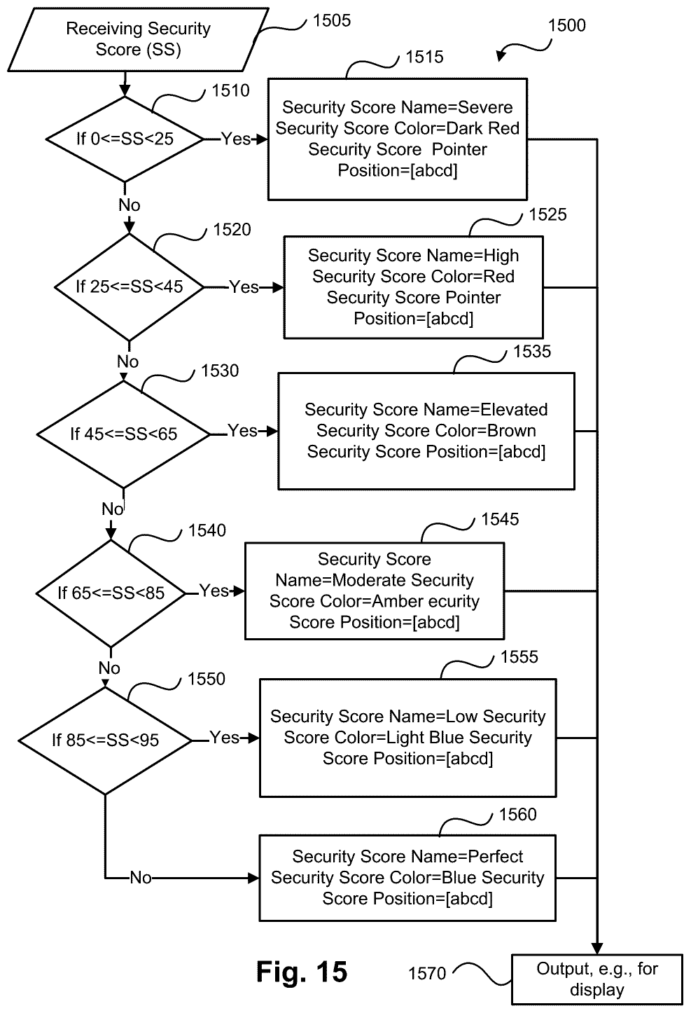

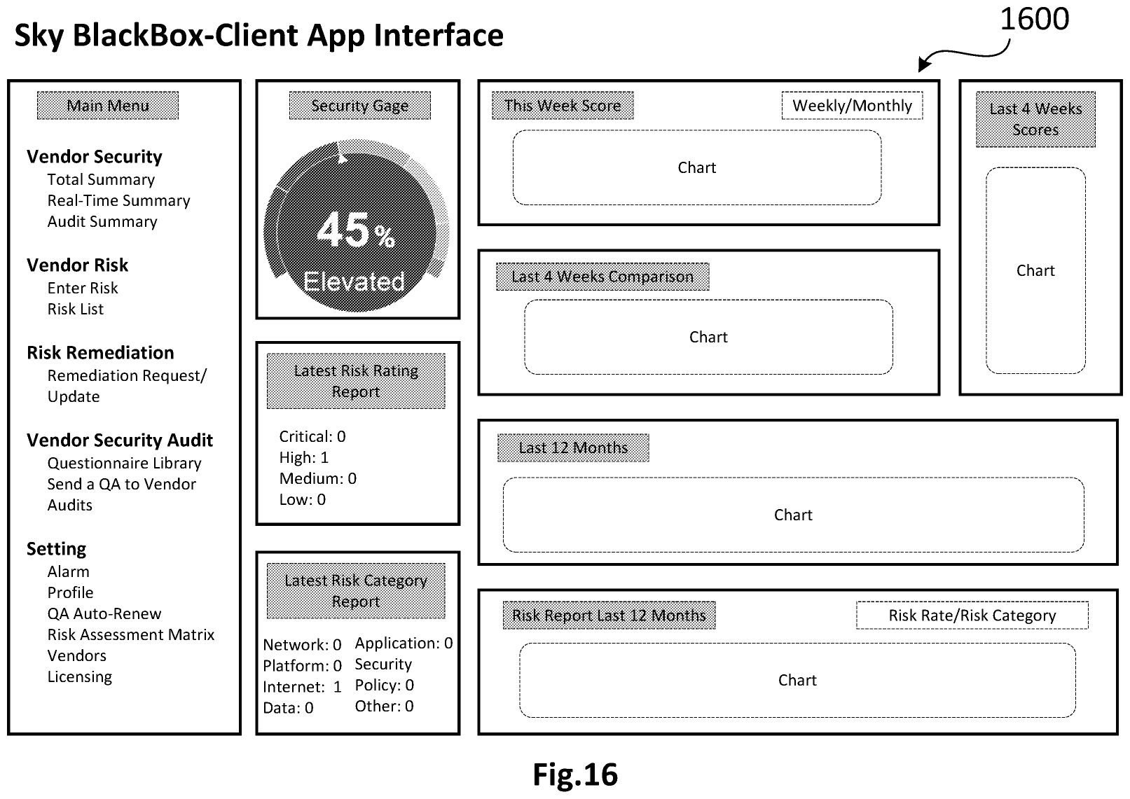

An example graphical representation is shown in FIG. 16. FIG. 16 shows an interactive graphical user interface (GUI) 1600 providing real time risk assessment for a client A. In particular, a user (typically authorized by the client A) is able to select graphical elements of the GUI 1600 to display a Summary of a current real-time report, a full summary across all third-party providers, a history of real-time risk assessment with respect to each third-party provider and/or collectively for all third-party providers for that client. Additionally, the user can select graphical elements of the GUI 1600 to request remediation and/or update of the report as well as to send a questionnaire to the third-party provider. The questionnaire can be based on the details of the vulnerability report, e.g. regarding specific risk categories, such as Network, Platform and/or Internet, identified in the report.

The method 200 concludes on completion of step 240.

For example, in some implementations of method 200, each third-party provider has multiple vulnerability scans with different scopes, schedules and configurations. When a new client is added to the third-party provider as a Real-Time VRM license, the third-party provider determines which scans are related to this client data/service. For example, the third-party provider may identify particular scopes, schedules and configurations for the client in vulnerability result CSV file names. Accordingly, when a DataCollector determines that a new file is added to the vulnerability scan result location, the DataCollector sends the new file to a Central server-based application (e.g. the third-party risk management module) with related data to identify which Client(s) the file is related to. The Central server-based application, for example, determines one or more clients to which the report relates by looking up Client IDs based on the Vendor ID specified in the file name. The Central server-based application determines the security score and risks for each client separately using the received vulnerability scan data, e.g. the vulnerability result file, and particular client risk profile.

In some implementations, the Central server-based application comprises instructions to:
1—Identify which clients are related to this scan result by looking up the database based on the Vendor ID determined from the file name and/or header of the vulnerability result file;
2—Determine the likelihood of each vulnerability; and, for each client:
3—Determine the Risk Rate for each vulnerability for the client as (Very High, High, Medium and Low risks) based on the calculated likelihood, the Default impact set up by the client for the third-party provider and Risk Assessment Matrix as read from the risk profile of the client;
4—In response to determining that the Risk Rates are determined for all vulnerabilities in the scan result, determine the Security Score of the report for the client using all the calculated risks for the third-party provider;
5—Generate and publish a detailed Real-Time report specific to the client for the third-party provider. The Real-Time report includes the Security score, Risk Rate, Categories to which the identified risks pertain, date and time of the report and the rest.
6—Repeat steps 3-5 for the next client to whom the vulnerability scan result is related until the Real-Time report is generated for all clients identified in step 1.

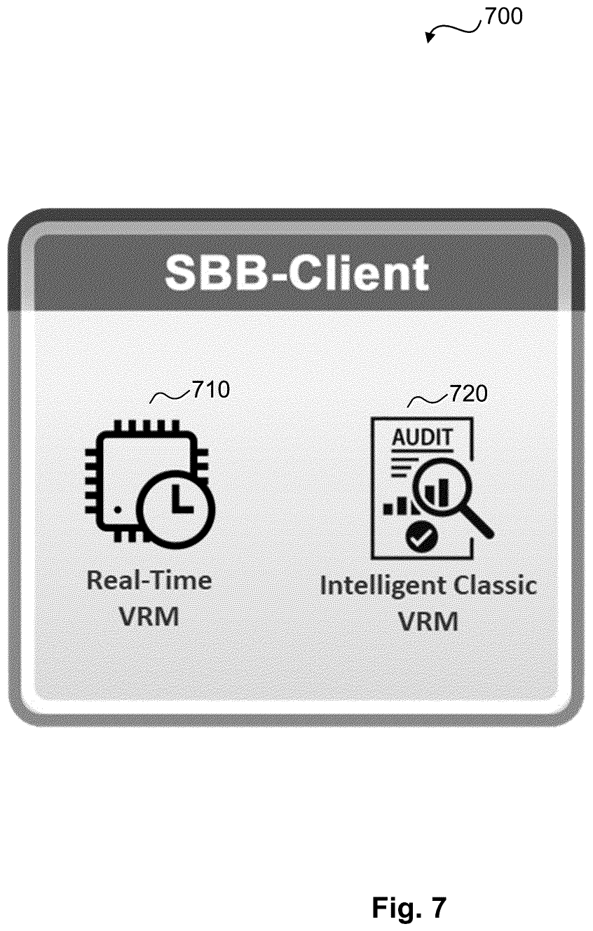

FIG. 7 demonstrates that some arrangements of the present disclosure provide two solutions within a client application 700 for managing risks associated with third-party providers, i.e. for Vendor Risk Management (VRM). The VRM solutions include a Real-Time VRM 710 and an Intelligent Classic VRM 720. The solutions 710 and 720 may be implemented as separate modules of the application program 133 running on a client device 320, the third-party device 340 and the server 370. Alternatively, the solutions 710 and 720 may be provided as separate application programs running on the client device 320, the third-party device 340 and the server 370. In some implementations, the client application 700 provides a client with a mixture of the Classic 720 and Real-Time 710 solutions to get the best VRM result.

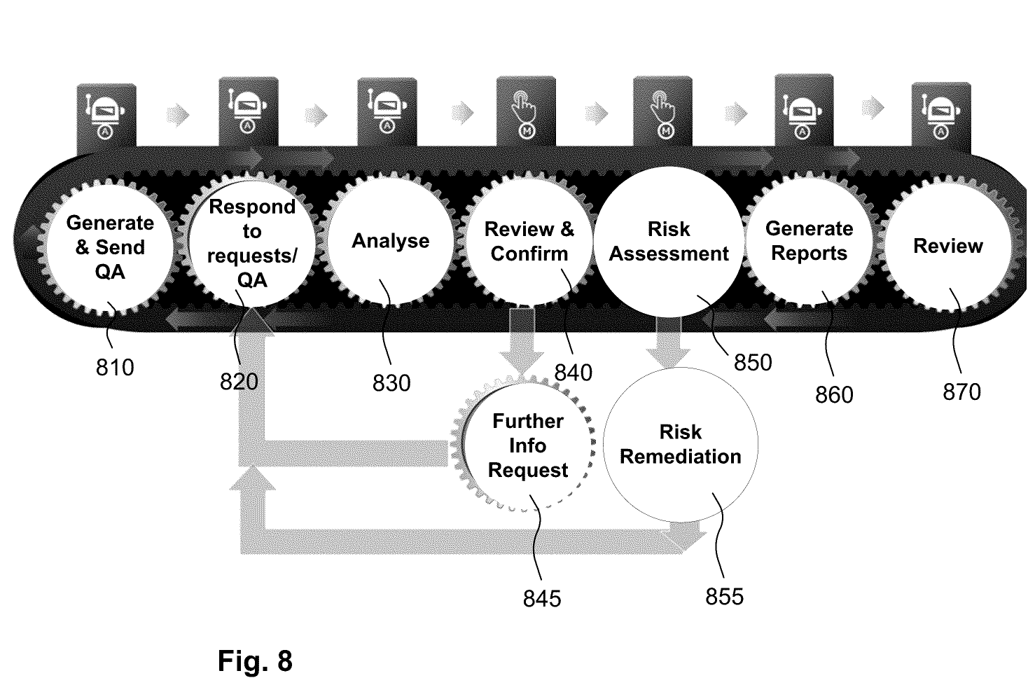

As discussed above, the Real-Time VRM is configured to provide to a client the VRM in real-time, i.e. up-to-date client specific vendor risk assessment as long as the client has a real-time VRM license. The Intelligent Classic VRM is intended to automate the process of generating a questionnaire based on a workflow of the client. Additionally, the Intelligent Classic VRM is intended to facilitate filling in the generated questionnaire for the vendor based on previous responses of the vendor to the requesting client and/or for any other client. Example workflow of the Intelligent Classic VRM is discussed below with references to FIG. 8.

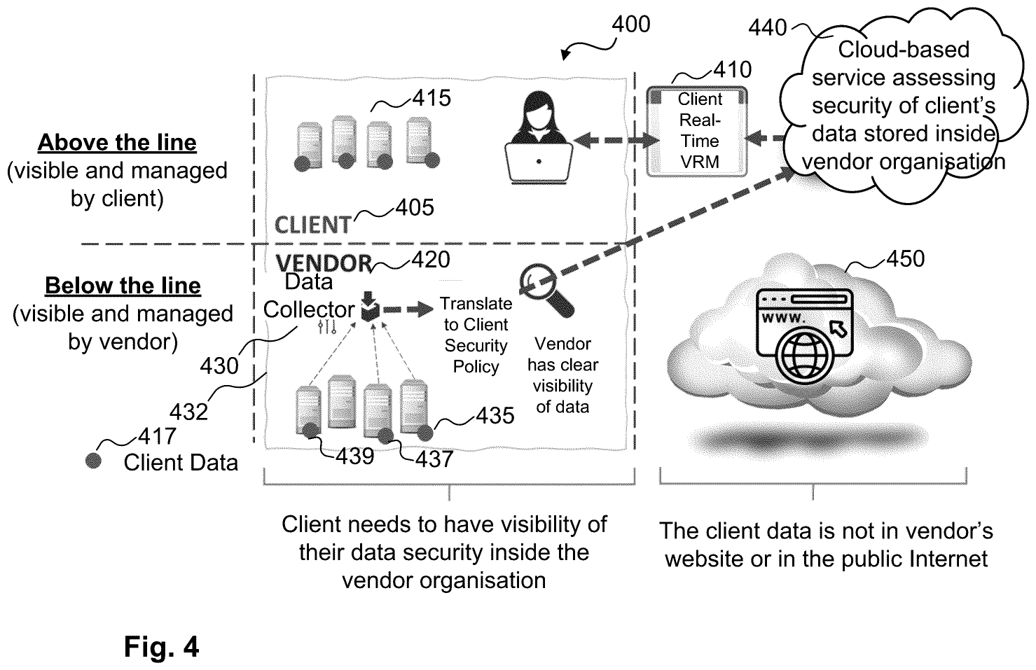

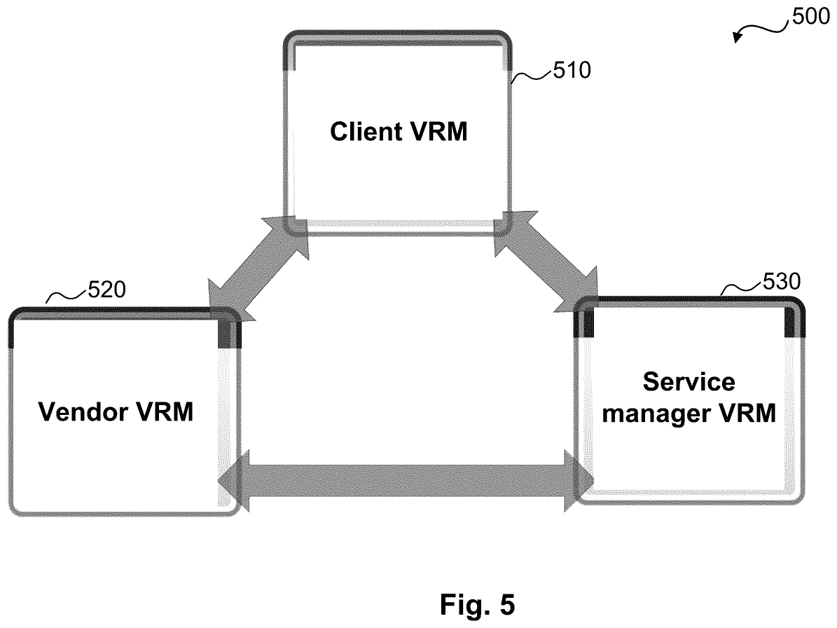

Each of the solutions 710 and 720 for vendor risk management may be facilitated via applications as shown in FIGS. 4 and 5, including a Client application 510, a Vendor application 520 and ServiceManager application 530 interacting with each other to provide a fully automated control of security of data available to the third party provider and belonging to the client.

The applications 510, 520 and 530 are customer facing applications. For example, the Client application 510 provides functionality for the client to request and/or review vendor risk assessment using either the Real-time VRM 710 or the Intelligent Classic VRM 720. The Vendor VRM allows the vendor to securely share results of scheduled client-specific vulnerability scans for clients subscribed for real-time VRM and/or having a current real-time VRM license (in case of the real-time VRM 710) and/or partially fill in the questionnaire in case of the Intelligent Classic VRM 720. In some implementations, the client-specific vulnerability scans are scheduled by the third-party provider (e.g. a vendor) based on internal security policy and standards adopted by the third-party provider.

In accordance with one implementation of the present disclosure, the service manager application 530 comprises a Central (server-based) application, e.g. application 440. Additionally, the service manager application 530 also comprises DataCollector application, e.g. application 430. The Central application and the DataCollector applications are discussed in more detail with reference to FIG. 4.

FIG. 4 shows an example implementation of the Real-Time VRM 400 of system 300 of controlling security of data belonging to a client and available to a third-party provider.

For example, as shown in FIG. 4, a client 405 owns data 417 which includes data 415 “above the line”, i.e. visible and managed by the client 405, and data “below the line”, i.e. data visible and managed by the vendor. For example, the “below the line” data may be stored at servers 435, 437 and 439 managed by the vendor.

The Real-Time VRM 400 is designed to provide almost a real time report of the client's data security when data 417 belonging to the client is in the hands of their vendor (also referred to as a third-party provider). For example, the client 405, via the client application 410, request assessment of security of data belonging to the client 405 and stored at the third-party provider. For example, the client 405 may purchase a real-time VRM license and send an onboarding request to one or more third-party providers handling data belonging to the client 405. In one arrangement, the one or more third-party providers have already adopted Real-Time VRM. However, if some of the third-party providers have not adopted Real-Time VRM, the client 405 may be notified about that and a message could be sent to such third-party providers to consider adopting Real-Time VRM.

Upon accepting the onboarding request, the vendor application 420 schedules an appropriate internal vulnerability scan for the client based on security policy and/or configuration adopted by the third-party provider. After the vendor provider accepts the onboarding request, whenever the vendor runs a vulnerability scan covering the client data or service to which the client is subscribed, a report, for example the report 1600, will be sent to the client. In some implementations, a daily based report may be sent even though there are multiple reports in one day to make it more efficient for the clients.

In some implementations, the vendor application 420 (or vendor for brevity) gives access to a container to the DataCollector application 430. The container includes an address provided by the vendor 420 and indicating where the results of the vulnerability scan are stored.

The DataCollector application 430 has access to a specific address that is provided by the vendor 420. The vendor application 420 exports internal vulnerability scan data related to the client data, e.g. client data stored at servers 435, 437 and 439, to the address accessible by the DataCollector application 430.

The DataCollector application 430 reads the vulnerability scan data from the address provided by the vendor 420 and finds and picks the required vulnerability data from the vulnerability scan data. The DataCollector application 430 sends the selected vulnerability data to the Central application 440.

The Central application 440 analyses the selected vulnerability data and produces the result/report, for example, in a form of a vendor security score. The Central application 440 effectively translates the selected vulnerability data into the Client's Risks based on the risk profile of the client. The risk profile can be viewed as perception of the risk for a particular client 4105 with respect to the vendor 420. The Central application also translates the Client's Risks to a percentage number as Vendor's Security Score.

In some implementations, the Central application is an application program 133 running on the server 370. The Central application 440 is configured to access the address (or location) storing the vulnerability scan data, determine a security score for the vendor based on the plurality of vulnerability metrics from the vulnerability scan data and the risk profile associated with the client. The Central application is also configured to cause a display device to display the security score determined for the vendor. For example, the Central application 440 may send instructions to the Client application 410 to cause a display device of the client 405 to display the vendor's security score.

For example, the DataCollector application 430 comprises instructions to check a destination address that vendor application 420 provided and see if a new vulnerability scan result file is added. If there is a new file, then the DataCollector application 430 reads the file, collects the required data and sends the collected data to the Central server-based application 440 as a binary code. The required data typically includes, for each detected vulnerability, a combination of an identifier of the scanned component and an associated vulnerability metric from the file, e.g. CVSS3 score and vulnerability metric values.

The Central server-based application 440 determines which client(s) is covered by the report or the binary code based on the file name of the vulnerability scan result file. The vulnerability metrics are typically stored in memory accessible by the Central server-based application 440 until the Central server-based application 440 determines security scores for all clients determined to be covered in the file.

The central server-based application 440 uses the collected information to generate a Real-Time report for each related client separately based on the risk profile of the client. In some implementations, the DataCollecor application 430 is located inside a network managed by the vendor 420. Alternatively, the DataCollecor application 430 is located outside of the network managed by the vendor 420 and is required to have access to vulnerability scan result file location.

For example, the DataCollector application 430 is a container placed inside or outside of the Vendor organisation network 432 to have access to the Vendor's internal vulnerability scan files related to the data 417. The internal vulnerability scan files can be stored in the CSV format. The DataCollector application 430 reads the CSV format file of the vulnerability scan data, identifies the required information (e.g. vulnerability metrics), selects the required vulnerability data and sends the selected vulnerability data to the Central application 440. The selected vulnerability data is sent as binary numbers to analyse and produce the report. The Central application 440 goes through each scanned component result in CSV file and picks the first highest risk for each component (based on the corresponding Common Vulnerability Scoring System (CVSS) number). For instance, there may be multiple vulnerabilities under CVSS-3 Base column for a first component (IP address: 163.189.7.48) in the scan result file having CVSS-3 Base scores 6.5, 7.5, 3.1, 7.5 respectively. In this example, for the first component, the DataCollector application will send data from the report to the Central application 440 only for the first CVSS-3 Base score at 7.5 (AV:N/AC:L/PR:N/UI:N/S:U/C:H/I:N/A:N) to calculate the related risk, not the data for the second CVSS-3 Base score at 7.5. An extract from the scan result file is provided in FIG. 18.

As discussed above, for the purposes of the present disclosure, the scan result file includes a plurality of columns comprising at least an identifier of a scanned component 1810 and vulnerability metric values 1820 for the identified vulnerability of the scanned component 1810. If multiple vulnerabilities are identified for the scanned component, the CSV file includes a row for each vulnerability for each scanned component. The scan result file may additionally include metadata related to the date and time of the scan, client name, number and identifiers of the scanned components. The scan result file may also include NetBIOS, IP status, QID, Title of threat, type of threat, severity of the vulnerability, scanned port, affected protocol of OSI model, whether the threat is over Secure Socket Layer (SSL), vendor reference, threat description, description of impact, description of solution, exploitability, associated malware, whether it is PCI (Payment Card Industry) vulnerability and category of the threat. In some implementations, a format of the scan result file is the format generally adopted in the art for vulnerability scans. However, a person skilled in the art would appreciate that other formats of the vulnerability scan result file are also possible.

The Central application 440 determines data related to the selected highest risk for each component (for example in a numerical representation) in the report for each component and calculates a likelihood of the vulnerability and a risk category, e.g. a risk rate.

In some implementations, the Central application 440 receives the scan result for each Vendor related to a specific Client. The Central application 440 determines exploitability metrics, impact metrics and scope from the CVSS numbers in vulnerability scan data for determining a risk associated with the vendor and security score calculation. Specific metrics and corresponding numerical representations are shown in Tables 3-5 below.

As a result, the Central application 440 determines the total number of risks for each scan with the risk rates (Low, Medium, High, Critical) and also identify the Risk Category of each risk as (Application, Data, Internet, Network, Platform, Security Policy, Other). If there are multiple scan reports for one day, the Central application 440 uses the above process to generate risk calculation and calculates one Security Score at the end of each day for all the identified risks, for example, as an average security score or as a minimum security score.

The Central application 440 generates the vendor Security Score for the vendor related to the specific client each time based on the determined total number of risks and the determined risk rates. Details of determining the total number of risks and generating the vendor security score are discussed below with references to FIGS. 10 to 15.

Additionally, the Central server-based application 440 outputs a distribution of risks across different risk categories as shown in 1610 of FIG. 16. Additionally or alternatively, the Central server-based application outputs, within each risk category, a distribution of different risk rates. An example distribution of different risk rates within each risk category is shown below in Table 7.

The Common Vulnerability Scoring System (CVSS) captures the principal technical characteristics of software, hardware and firmware vulnerabilities. The CVSS data include numerical scores indicating the severity of a vulnerability relative to other vulnerabilities. Tables 3-5 show exploitability, impact and scope metrics respectively.

TABLE 3
Example Exploitability Metrics with corresponding
numerical representations

| Exploitability | |
|---|---|
| Metrics | Amount options with numbers |
| AV | N = 0.85, AN = 0.62, L = 0.55, P = 0.2 |
| AC | L = 0.77, H = 0.44 |
| PR | N = 0.85, |
| | L = 0.62 (if S = Unchanged), 0.68 (if S = Changed) |
| | H = 0.27 (if S = Unchanged), 0.5 (if S = Changed) |
| UI | N = 0.85, R = 0.62 |

TABLE 4
Example Impact Metrics with corresponding
numerical representations

| Impact Metrics | Amount options with numbers |
|---|---|
| C | N = 0, L = 0.22, H = 0.56 |
| I | |
| A | |

TABLE 5
Example Scope Metric with corresponding
numerical representations

| Scope | Amount options with numbers |
|---|---|
| S | Changed/Unchanged |

Exploitability metrics shown in Table 1 reflect the characteristics of the vulnerable component. Exploitability metrics include an attack vector (AV) metric, an attack complexity metric (AC), a privileges required (PR) metric and a user interaction (UI) metric.

The AV metric reflects the context by which vulnerability exploitation is possible. The value of the AV metric will be larger the more remote (logically, and physically) an attacker can be in order to exploit the vulnerable component. The values of the AV metric include:
Network (N), i.e. the vulnerable component is bound to the network stack, i.e. “remotely exploitable vulnerability”;
Adjacent (AN), i.e. the vulnerable component is bound to the network stack but the attach is limited to a logically adjacent topology, i.e. the attack can be launched from the same shared physical (e.g., Bluetooth or IEEE 802.11) or logical (e.g., local IP subnet) network, or from within a secure or otherwise limited administrative domain;
Local (L), i.e. the vulnerable component is not bound to the network stack and the attacker's path is via read/write/execute capabilities by accessing the target system either locally or remotely, e.g. via SSH, or by relying on User Interactions; and
Physical (P), i.e. requires the attacker to physically touch or manipulate the vulnerable component.

Since the number of potential attackers for a vulnerability that could be exploited from across a network is larger than the number of potential attackers that could exploit a vulnerability requiring physical access to a device, the values of the metrics are determined based on remoteness of the attack. For example, the Network attack vector has a value of 0.85, the Adjacent attack vector has a value of 0.62, the Local attack vector had a value of 0.55 and the Physical attach vector has a value of 0.2.

The AC metric describes the conditions beyond the attacker's control that must exist in order to exploit the vulnerability. The value of the AC metric will be larger the less specialized conditions the attach require. The values of the AC metric include:
Low (L) where specialized access conditions or extenuating circumstances do not exist, i.e. an attacker can expect repeatable success when attacking the vulnerable component; and
High (H) where the attacker must gather knowledge about the environment, prepare the environment; and/or inject themselves as a man-in-the-middle.

For example, the Low AC metric has a value of 0.77, the High Attack complexity has a value of 0.44.

The PR metric describes the level of privileges an attacker must possess before successfully exploiting the vulnerability. If no privileges are required, the value of the metric is higher. For example, the PR metric values can include none (N), e.g. when authorisation prior to attack is not required, Low (L), e.g. when basic user capabilities are sufficient, or High (H), e.g. when administrative access is required.

For example, the None PR metric value can have a value 0.85. A Low PR metric value can have a value 0.62 if the Scope metric value is Unchanged and 0.68 is the Scope metric value is Changed. A High PR metric value can have a value 0.27 if the Scope metric value is Unchanged and 0.5 is the Scope metric value is Changed.

The UI metric determines whether the vulnerability can be exploited solely at the will of the attacker, or whether a separate user (or user-initiated process) must participate in some manner. For example, the UI metric values can include none (N), e.g. when the vulnerability can be exploited without interaction from any user, or Required (R), e.g. when a separate user needs to take some action before the vulnerability can be exploited. For example, the None UI metric value can have a value 0.85. A Required UI metric value can have a value 0.62.

The Scope metric captures whether a vulnerability in one vulnerable component impacts resources in components beyond its security scope, i.e. when the impact of a vulnerability impacts components outside the security scope in which vulnerable component resides, a Scope change occurs. The metric values can include Unchanged (U), e.g. when the vulnerability can only affect resources managed by the same security authority, or Changed (C), e.g. when the vulnerability can affect resources beyond the security scope managed by the security authority of the vulnerable component.

The Impact metrics shown in Table 4 capture the effects of a successfully exploited vulnerability on the component that suffers the worst outcome that is most directly and predictably associated with the attack. The Impact metrics can include a Confidentiality (C) metric, an Integrity (I) metric, and an Availability (A) metric to either the vulnerable component, or the impacted component, whichever suffers the most severe outcome. Each of the impact metrics has a meaning generally adopted in the art and may have a value specifying None impact, Low impact or High impact.

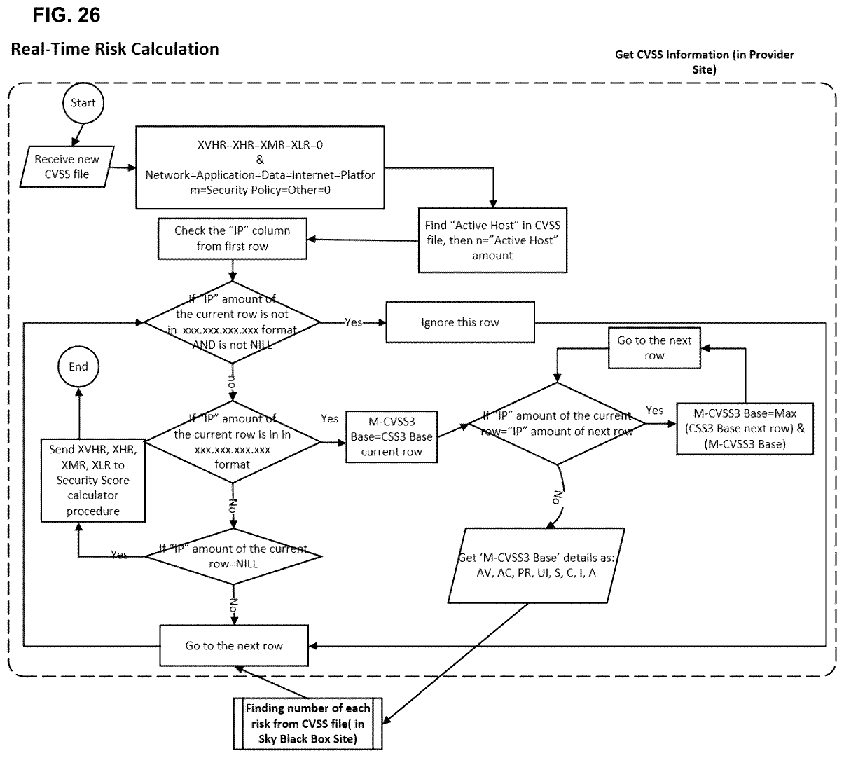

FIG. 10 is a flow-chart of method 1000 of determining a plurality of vulnerability metrics for the data of the client at the third-party provider in accordance with one implementation of the present disclosure. At least some steps of the method 1000 are executed within step 220 of the method 200. In some implementations, all step of the method 1000, except step 1070, are executed by the DataCollector 430, which may be run on a processor 105 of the provider device 355 under control of instructions stored in memory 106. Step 1070 in this implementation is executed by the Central server-based application 440 run a processor 105 of the server 370. The method 1000 effectively receives a CVSS scan file from vendor scan and collects the required data. An example of getting CVSS information is shown in FIG. 26.

The method 1000 commences at step 1005 of receiving a new CVSS file, for example, from the provider 340. The CVSS file is in CSV format. The processor 105 under control of instructions stored in memory 106 proceeds from step 1005 to a step 1010 of resetting values for each risk category. For example, values for each risk category can be set to 0.

Risks can be categorized based on a risk rate, e.g. Very High, High, Moderate and Low, as well as based on related component category to which the risk pertains, e.g. Network, Application, Data, Internet, Platform, Security Policy and Other. In some implementations, the risk category is determined for each risk in the determined risk rate count. Alternatively, each risk may be assigned a risk rate category and a related component sub-category so that risks can be grouped either based on the risk rate category, the related component category or based on a combination of the risk rate category and the related component category.

The method 1000 proceeds from step 1010 to a step 1015 of finding an active host in the CVSS file and setting a variable n to the “Active Host” amount in the CVSS file. For example, the processor 105 at step 1015 identifies the total number of active hosts in the report and uses the total number of active hosts as the total number of components that have been scanned in the report. Additionally, the processor 105 at step 1015 also checks any component that has IP address and a CVSS-3 score to identify the risk in the report. For example, rows in the report with empty CVSS-3 scores are ignored in some implementations.

Step 1015 continues to a step 1020 of determine the IP address (“IP” amount) column from the first row of the CVSS file to identify the scanned component. If the method 1000 determines that “IP” amount of the current row is not in xxx.xxx.xxx.xxx format and is not NILL at step 1025, the method 1000 proceeds to a step 1030 of ignoring the current row followed by a step 1035 of moving to the next row.

Otherwise, if the method 1000 determines that “IP” amount of the current row is in the xxx.xxx.xxx.xxx format or is NILL at step 1025, the method 1000 proceeds to a step 1040 of determining if the “IP” amount of the current row is in the xxx.xxx.xxx.xxx format. If the method 1000 determines at step 1040 that the “IP” amount of the current row is in the xxx.xxx.xxx.xxx format, the method 1000 proceeds to a step 1045 of determining the maximum CVSS-3 score for the component (IP address) (M-CVSS3 Base value). The M-CVSS3 Base value may be determined at step 1045 as the CVSS-3 Base value of the current row.

Otherwise, if the method 1000 determines at step 1040 that the “IP” amount of the current row is not in the xxx.xxx.xxx.xxx format, the method 1000 proceeds to a step 1050 of determining if the “IP” amount of the current row is NILL. If the “IP” amount of the current row is NILL at step 1050, i.e. the previous row was the last row in the CVSS file, the method 1000 proceeds to step 1055 of sending XVHR, XHR, XMR, XLR to Security Score calculator procedure discussed in more detail with references to FIGS. 14 and 15. The method 1000 concludes on completion of step 1055.

If the “IP” amount of the current row is not NILL at step 1050, the method 1000 returns to step 1035 of moving to the next row of the CVSS file or fetching the next row of the CVSS file.

Returning to step 1045, the method 1000 continues from step 1045 to a step 1050 of determining if the “IP” amount of the current row is equal to an “IP” amount of next row. If the result of step 1050 is negative, i.e. the “IP” amount of the current row is not equal to the “IP” amount of next row, the method 1000 continues to a step 1057 of getting ‘M-CVSS3 Base’ details as values for the following metrics discussed above AV, AC, PR, UI, S, C, I, A, As shown in the extract of the vulnerability report, the value of each metric AV, AC, PR, UI, S, C, I, A can be provided in the CVSS3 column. As such, the value of each metric can be determined by parsing the CVSS3 column.

Step 1057 proceeds to a step 1070 of determining the number of risks in each risk category, for example, the number of risks XVHR, XHR, XMR, XLR in the Very High, High Moderate and Low risk categories and well as number of risks in each of related component category, for example, in Network, Application, Data, Internet, Platform, Security Policy and Other categories. In some implementations, step 1070 is executed on the processor 105 of the server 370 under control of instructions stored in memory 106.

Specific implementation details of step 1070 in accordance with one implementation of the present disclosure are discussed with references to FIGS. 11 to 13. Step 1070 continues to step 1035 of fetching the next row in the CVSS file.

Returning to step 1050, if the result of step 1050 is affirmative, i.e. the “IP” amount of the current row equals the “IP” amount of next row, the method 1000 continues to a step 1060 of determining M-CVSS3 Base value as a maximum of a CVSS3 Base value for the next row and the M-CVSS3 Base value for the current row. The M-CVSS3 Base value is the maximum CVSS3 Base value for a component, e.g. an IP address. Step 1060 proceeds to a step 1065 of moving to the next row. Step 1065 returns to step 1050.

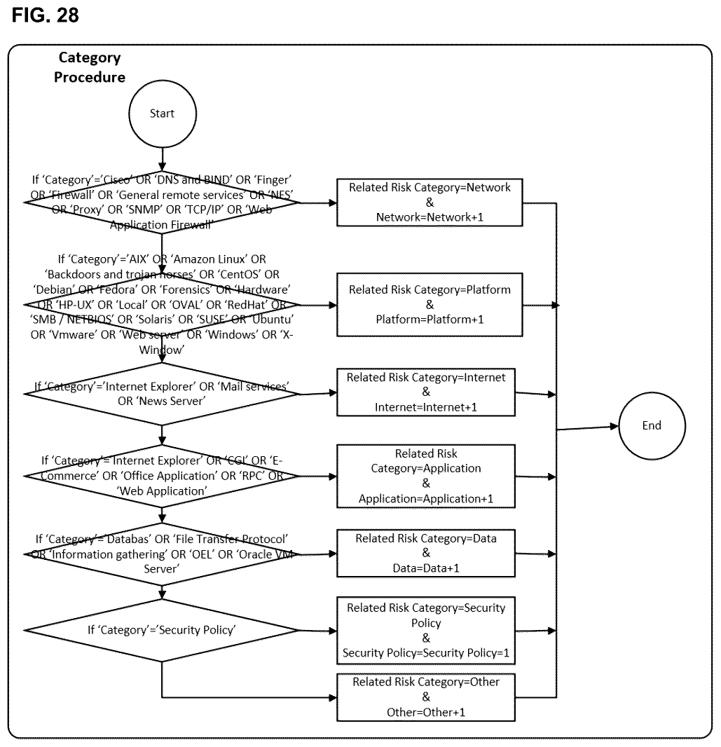

FIGS. 11 to 13 are flowcharts showing processing of categorising the risks based on client specific requirements and determining number of risks in each category. In accordance with some implementations, at least some steps of methods of FIGS. 11 to 13 are executed within steps 230 and 1070 discussed above. An example implementation of risk category procedure is shown in FIG. 28.

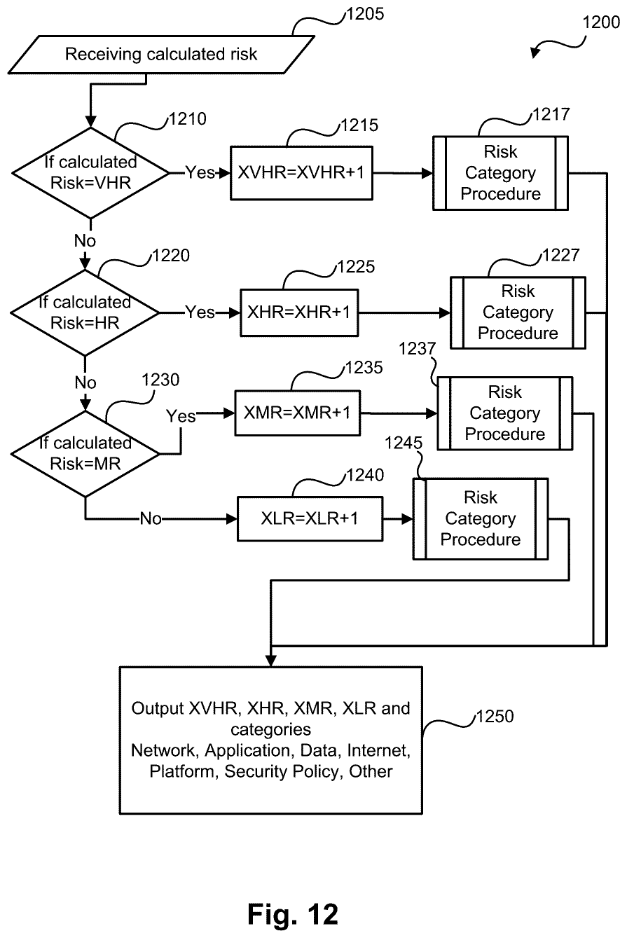

For example, when a new CVSS file is received, the DataCollector application 430 collects the required information and sends the collected data to the Central application 440 as a binary code. The process of collecting required data by the Data Collector application 430 is described above with references to FIG. 10. The Central application 440 uses a process shown in FIG. 11 to determine Likelihood and Impact of each vulnerability. The Central application 440 uses the determined Likelihood and Impact for each vulnerability in addition to the internal Risk Assessment Matrix (RAM) storing the risk profile of the client to calculate the risk rate elated to each vulnerability for the client. Additionally, the Central application 440 uses FIG. 12 to calculate the total number of each Risk Rate (Very High, High, Medium, Low) in a vulnerability scan result file for the client.

The Central application 440 also uses FIG. 14 to calculate the Security Score based on the total Risk Rates that is identified in a scan result for the client. The Central application 440 additionally uses FIG. 15 to identify a display representation of the determined security score, e.g. the color code, name and a pointer, and generate a graphical user interface for the calculated Security Score for the client. The Central application 440 also generates a detailed report for the client. When the Central application 440 completes the whole process for the client, the central application 440 moves to the next client related to the scan result. The next client can be determined based on the scan result file name. The central application 440 continues until the above process is complete for all clients related to the received scan result.

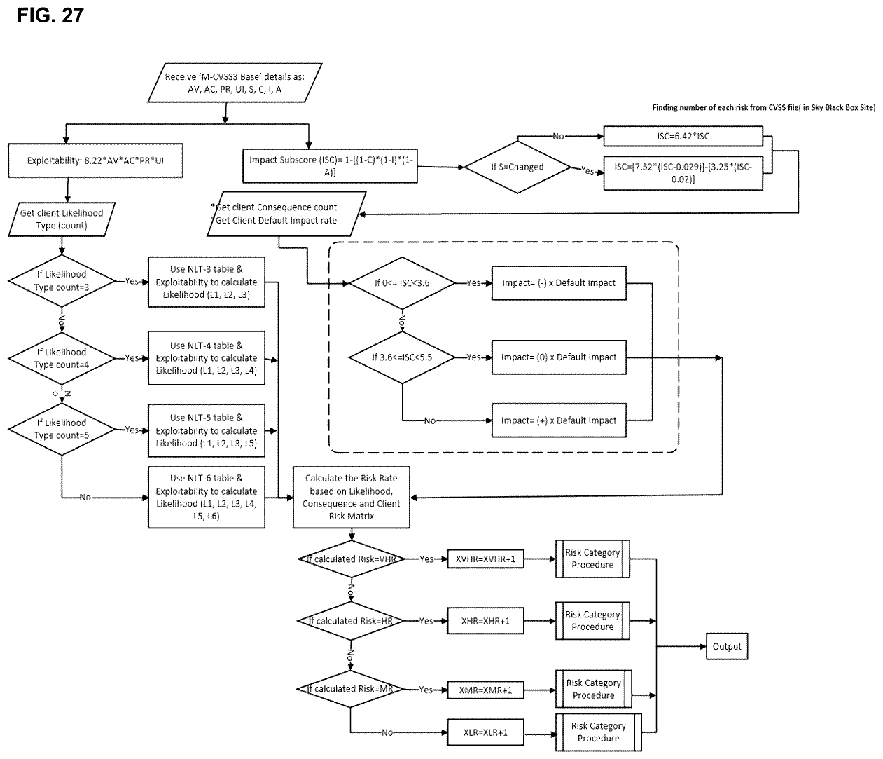

FIG. 11 is a flowchart of method 1100 of determining the Risk Rate in accordance with one implementation of the present disclosure. The method 1100 is executed on the processor 105 of the server 370 under control of instructions stored in memory 106. The method 1100 effectively gets CVSS file and generates likelihood/impact level for each vulnerability for each client related to the vendor which ran the scan. An example of finding the number of reach risk from a CVSS file (in server side) is shown in FIG. 27.

The method 1100 commences at a step 1105 of receiving ‘M-CVSS3 Base’ details as values of the AV, AC, PR, UI, S, C, I and A discussed above for a scanned vulnerable component. The method 1100 proceeds from step 1105 to execute a brunch related to exploitability (starting with a step 1110 of determining exploitability of a vulnerability) and a brunch related to impact (starting with a step 1162 of determining an impact score). In some implementations, the brunches are executed in parallel. Alternatively, the brunches can be executed sequentially.

At step 1110, the processor 105 under control of instructions stored in memory 106 determines an exploitability score. In some implementations, the exploitability score can be determined as a product of values of the AV, AC, PR and UI metrics adjusted using a weighting coefficient stored in memory 106. The weighting coefficient is 8.22 in some implementations. However, other weighting coefficients are also possible.

The method 1100 continues from step 1110 to a step 1115 of determining client Likelihood Type (or count). The client likelihood type can range from 3 to 6. In some implementations, the Likelihood count corresponds to the number of rows in the RAM of the client.

For example, as discussed above, in some implementations, the risk category is determined based on a risk profile of the client, which is stored in an internal Risk Assessment Matrix (RAM). The RAM is typically from 3×3 (3×Likelihood by 3×Impact) to 6×6. For instance, a RAM could be 4×5 or 6×4 or any other combination. As such, the likelihood count for a 4×5 RAM would be 4.

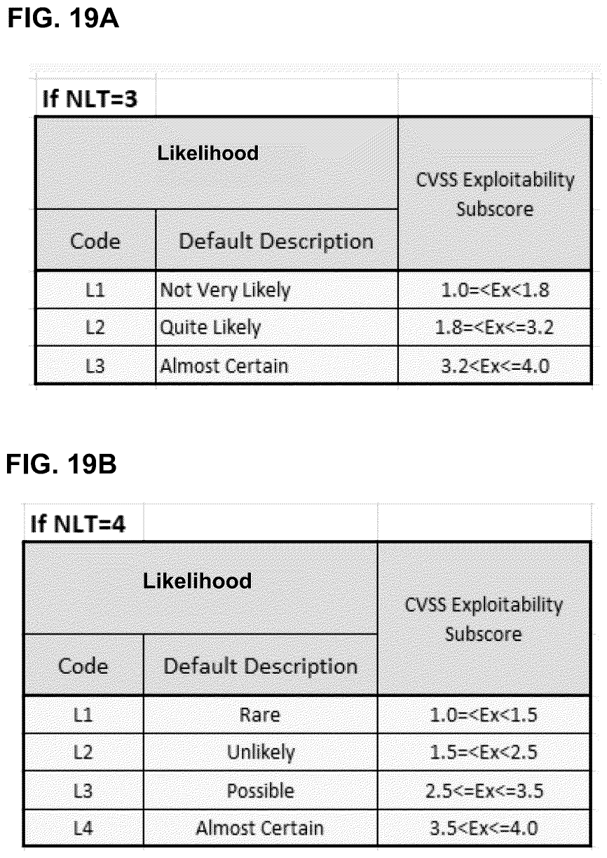

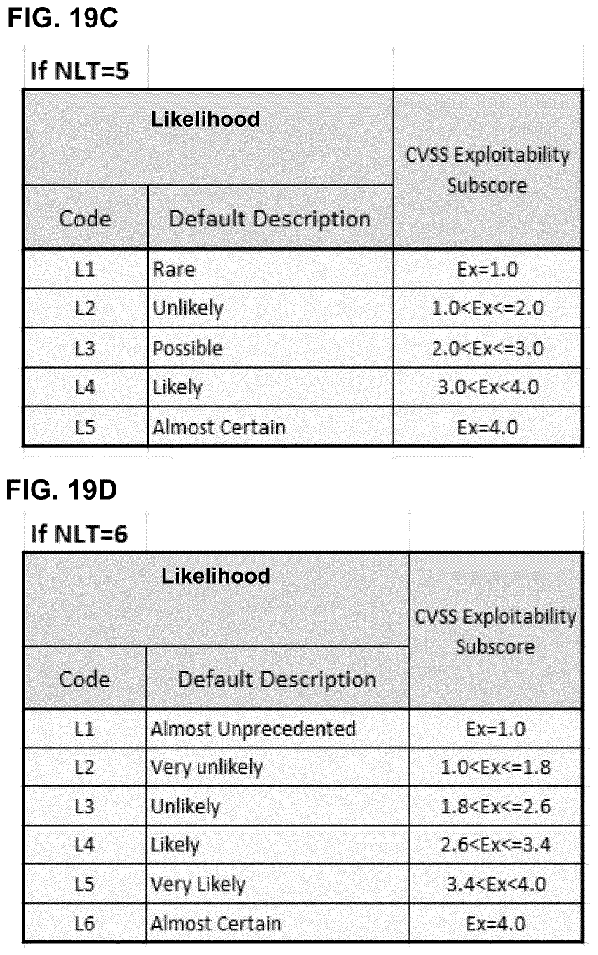

Each likelihood type or count is associated with a corresponding Likelihood Reference Table (NLT) for that likelihood count. Each likelihood reference table includes a likelihood code or index, for example, L1, L2, L3 etc, likelihood description, and a CVSS exploitability subscore for the likelihood code within the likelihood type. Example likelihood reference tables are shown in FIGS. 19A, 19B, 19C and 19D.

The method 1100 proceeds from step 1115 to steps 1120 to 1150 of determining the likelihood code or index based on the determined exploitability score and the likelihood reference table corresponding to the determined client likelihood type. For example, the likelihood index is determined by comparing the determined exploitability score against thresholds set in the NLT for the determined likelihood count, identifying a row in the NLT where the determined exploitability score satisfies the thresholds and using the likelihood index specified for the identified row.

At step 1120, the method 1100 determines whether the Likelihood Type Count is 3. If affirmative, the method 1100 uses an NLT-3 table and the determined exploitability score to determine a Likelihood index (L1, L2, L3) at step 1125. For example, if the likelihood count is 3 and the determined exploitability score is 3, the determined likelihood index is L2 based on the NLT-3 table.

Alternatively, if the method 1100 determines at step 1120 that the Likelihood Type Count is not 3, the method 1100 proceeds to step 1130 of determining whether the Likelihood Type Count is 4. If affirmative, the method 1100 uses an NLT-4 table and the determined exploitability score to determine Likelihood (L1, L2, L3, L4) at step 1135.

If the method 1100 determines at step 1130 that the Likelihood Type Count is not 4, the method 1100 proceeds to step 1140 of determining whether the Likelihood Type Count is 5. If affirmative, the method 1100 uses an NLT-5 table and the determined exploitability score to calculate the likelihood index (L1, L2, L3, L4, L5) at step 1145. Otherwise, the method 1100 proceeds to using an NLT-6 table and the determined exploitability score to calculate the likelihood index (L1, L2, L3, L4, L5. L6) at step 1150.

The method 1100 continues from steps 1125, 1135, 1145 and 1150 to a step 1155 of determining the risk rate based on the determined likelihood, consequence and client risk matrix. Step 1155 is discussed in more detail below.

Returning to the second brunch, the method 1100 at step 1162 determines an impact score ISC. The impact score is determined based on values of the metrics C, I and A received at step 1105. In some implementations, the impact score is determined as follows:

$$ISC = 1 - [ ( 1 - C ) * ( 1 - I ) * ( 1 - A ) ] \qquad ( 1 )$$

The method 1100 proceeds from step 1162 to a step 1165 of determining whether a value of the Scope metric is “Changed”. If the value of the scope metric is “Changed”, the method 1100 updates at a step 1167 the Impact score determined at step 1162 using equation (2):

$$ISC = [ 7.52 * ( ISC - 0.029 ) ] - [ 3.25 * ( ISC - 0.02 ) ] \qquad ( 2 )$$

Otherwise, if the method 1100 determines at step 1165 that the value of the scope metric is “Unchanged”, the method 1100 updates at a step 1170 the Impact score determined at step 1162 using equation (3).

$$ISC = 6.42 * ISC \qquad ( 3 )$$

A person skilled in the art would appreciate that different numerical values used for adjustment of the impact score ISC in equations (2) and (3) can be used.

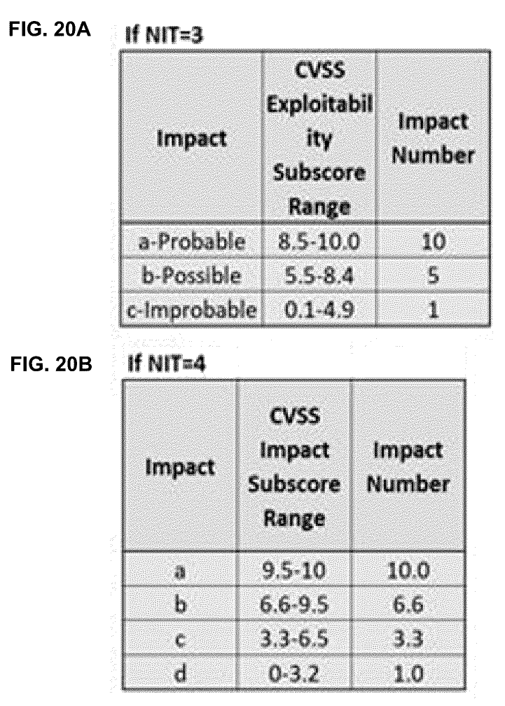

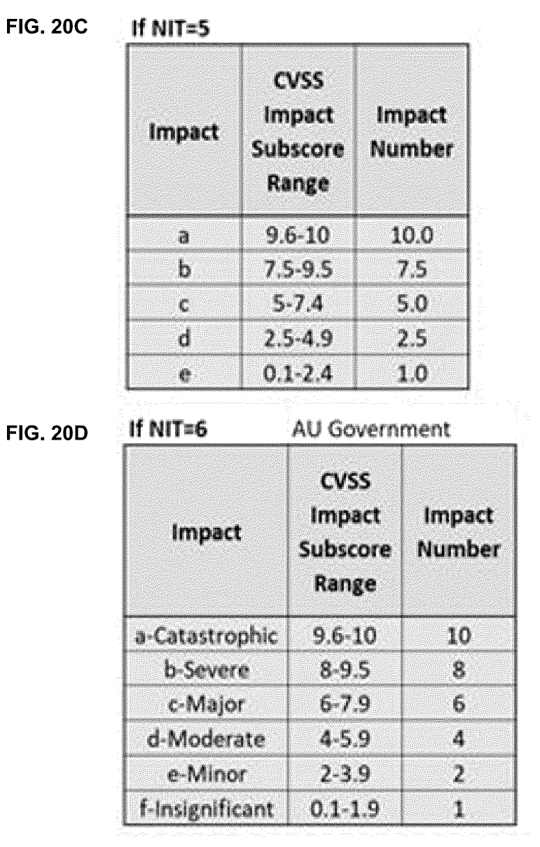

Steps 1167 and 1170 continue to a step 1175 of receiving client consequence count and receiving a client default impact rate for the vendor. The client default impact rate for the vendor and the consequence count are stored in the client profile. Example client impact (consequence) tables are shown in FIGS. 20A, 20B, 20C and 20D.

In some implementations, the consequence count and the likelihood count are determined from an input provided by the client. For example, when the client signs up, the client inserts or sets up a Risk Assessment Matrix (RAM) to be used for assessing risks for the client. In the RAM, the client typically inserts the RAM likelihood and consequence count and sets each cell value in the RAM as Very High, High, Medium and Low risk based on internal security policy of the client. Each client determines the default impact rate (consequence) for each vendor in the vendor profile information when the client adds or configures a vendor profile. The consequence (impact) means if the data of the client at vendor's hands is compromised or the vendor service fails, what will be the impact on the business of the client.

The method 1100 proceeds from step 1175 to steps 1177 to 1190 of determining an impact rate based on the determined impact score ISC and the client default impact rate for the vendor specific to the client consequence count.

Specifically, at step 1177 the method 1100 determines whether the ISC score is equal to or more than 0 and less than 3.6. If step 1177 returns affirmative, the method 1100 downgrades the default client impact rate for the vendor. The impact can be downgraded by multiplying the default client impact rate for the vendor by a weighting coefficient between 0 and 1. Otherwise, the method 1100 proceeds to a step 1185 of determining whether the ISC score is equal to or more than 3.6 and less than 5.5. If step 1185 returns affirmative, the method 1100 determines the current default client impact rate for the vendor should remain unchanged. Otherwise, the method 1100 proceeds to a step 1190 of upgrading the default client impact rate for the vendor. Upgrading can be implemented by multiplying the default client impact rate for the vendor by a weighting coefficient higher than 1. The adjusted default client impact rate for the vendor is translated into an impact index based on threshold values specified in the NIT corresponding to the consequence count. For example, the impact index is determined by comparing the determined impact score against thresholds set in the NIT for the determined consequence count, identifying a row in the NIT where the determined impact score satisfies the thresholds and using the impact index specified for the identified row.

Alternatively, downgrading of the default client impact rate for the vendor can be implemented by decreasing the default client impact rate index for the vendor by 1 and upgrading the default client impact rate for the vendor can be implemented by increasing the default client impact rate index for the vendor by 1. For example, if the default impact index (default impact for brevity) for the vendor is C2 “Severe” and the consequence count is 6, the adjusted value of the impact would be C1 “Catastrophic” at step 1190 as per the impact table.

In other words, the impact to the business of the client is determined using the default impact of the vendor to the client. As shown in steps 1175-1190, the impact to the client can be determined by adjusting the default vendor impact by one level higher or one level lower based on the impact score determined from vulnerability metrics C, I and A. For instance, if the risk is an existing risk and was identified before, the impact will go one level lower and etc.

Steps 1180, 1187 and 1190 continue to step 1155 of determining the risk rate based on the likelihood determined at steps 1110-1150, impact (or consequence) determined at steps 1162-1190 and a client risk matrix. In particular, the impact for the client, e.g. the adjusted vendor default impact, is used in the RAM table to determine risk rates.

For example, if the RAM for the client is 4×5, and the Likelihood index is calculated L2 based on the NLT-4 table and the Impact (Consequence) index is determined as C2 based on the NIT-5 table, the Central application 440 would look up the RAM for the client shown in Table 7 using L2 and C2 indices and determine the Risk Rate as High based on L2 Likelihood and C2 Consequence (Impact) indices.

In some implementations, the NIT and NLT tables are also considered to be a part of the client risk profile. Alternatively, standard NIT and NLT tables are used depending on the number of columns and rows respectively in the RAM for the client.

TABLE 6
Example RAM

| | Impact (Consequence) | | | | |
|---|---|---|---|---|---|
| | C1 - | C2 - | C3 - | C4 - | C5 - |
| Likelihood | Catastrophic | Severe | Major | Moderate | Minor |
| L1 - Almost | Very | Very | Very | High | High |
| Certain | High | High | High | | |
| L2 - Very Likely | Very | High | High | High | Medium |
| | High | | | | |
| L3 - Likely | High | Medium | Medium | Medium | Medium |
| L4 - Very | Medium | Low | Low | Low | Low |
| Unlikely | | | | | |

The method 1100 continues from step 1155 to a step 1160 of determining risk rate numbers XVHR, XHR, XMR, XLR and categories Network, Application, Data, Internet, Platform, Security Policy, Other. Implementation details of step 1160 are discussed with references to FIGS. 12 and 13. method 1100 concludes on completion on step 1160.

FIG. 12 is a flowchart showing a method 1200 of determining risk rates count and corresponding categories based on the determined risk rate in accordance with one implementation of the present disclosure. The method 1200 is executed on a processor 105 of the server 370 under control of instructions stored in memory 106. The method 1200 essentially receives the risk rate and calculates the security score for each vendor of a client.

The method 1200 commences at a step 1205 of receiving the risk rate, for example, as determined at step 1155. Step 1205 continues to steps 1210-1245 of determining the number of risks for each risk rate and each risk category.

Specifically, the method 1200 determines at a step 1210 whether the calculated risk rate is Very High. If affirmative, the method 1200 proceeds to a step 1215 of incrementing the Very High Risk count (XVHR) by 1. Step 1215 continues to a step 1217 of determining a related component risk category for the very high risk rate and incrementing the very high risk count for the related risk category.

Returning to step 1210, if the method 1200 determines at step 1210 that the calculated risk rate is not Very High, the method 1200 proceeds to a step 1220 of determining whether the calculated risk rate is High Risk. If affirmative, the method 1200 proceeds to a step 1225 of incrementing the High Risk count (XHR) by 1. Step 1225 continues to a step 1227 of determining a related risk component category for the high risk rate and incrementing the high risk rate count for the related risk category.

Otherwise, if the method 1200 determines at step 1220 that the calculated risk rate is not High, the method 1200 proceeds to a step 1230 of determining whether the calculated risk rate is Moderate. If affirmative, the method 1200 proceeds to a step 1235 of incrementing the Moderate Risk count (XMR) by 1. Step 1235 continues to a step 1237 of determining a related component category for the moderate risk rate and incrementing the moderate risk rate count for the related risk category.

If the method 1200 determines at step 1230 that the calculated risk rate is not Moderate, the method 1200 proceeds to a step 1240 of incrementing the Low Risk count (XLR) by 1. Step 1240 continues to a step 1245 of determining a related component category for the low risk rate and incrementing the low risk rate count for the related category. The risk category procedure at steps 1217, 1227, 1237 and 1245 is discussed in more detail with references to FIG. 13.

For example, if the method 1200 determines that there are 3 Very High Risks and 1 Low Risk for a particular third-party provider, the method 1200 also determines that out of the determined High Risks, two high risks are in Network category, and 1 high risk is in Data category and the only determined Low Risk is in Platform category. The example distribution of risks is shown in Table 7 below.

TABLE 7
Distribution of Risk Rate Counts Across Different Risk Categories

| | | | | | | |
|---|---|---|---|---|---|---|
| | | | | | Security | |
| Network | Platform | Internet | Application | Data | Policy | Other |

Very High Risk
3

| | | | | | | |
|---|---|---|---|---|---|---|
| 2 | 0 | 0 | 0 | 1 | 0 | 0 |

High Risk
0

| | | | | | | |
|---|---|---|---|---|---|---|
| 0 | 0 | 0 | 0 | 0 | 0 | 0 |

Medium Risk
0

| | | | | | | |
|---|---|---|---|---|---|---|
| 0 | 0 | 0 | 0 | 0 | 0 | 0 |

Low Risk
1

| | | | | | | |
|---|---|---|---|---|---|---|
| 0 | 1 | 0 | 0 | 0 | 0 | 0 |

The method continues from steps 1217, 1227, 1237 and 1245 to a step 1250 of outputting XVHR, XHR, XMR, XLR values and categories Network, Application, Data, Internet, Platform, Security Policy, Other. The method 1200 concludes on completion of step 1250.

FIG. 13 is a flowchart showing a method 1300 of determining related scanned component risk categories (or simply “related risk category”) and corresponding risk counts within each category in accordance with one implementation of the present disclosure. The method 1300 is executed on the processor 105 of the server 370 under control of instructions stored in memory 106. The method 1300 essentially identifies the risk component category for each risk detected for the vendor.

The method 1300 commences at a step 1305 of receiving a category for the scanned component for which the risk rate of the method 1200 is determined. Step 1305 continues to steps 1310-1370 of determining the related component category and the number of risks for each related component category.

Specifically, the method 1300 determines at a step 1310 whether the scanned component category is network related. For example, the scanned component category is considered network related if ‘Category’ is ‘Cisco’, ‘DNS, ‘BIND’, ‘Finger’, ‘Firewall’, ‘General remote services’, ‘NFS’, ‘Proxy’, ‘SNMP’, ‘TCP/IP’ or ‘Web Application Firewall’. If affirmative, the method 1300 proceeds to a step 1315 of determining the related risk category as a Network category and incrementing the risk count for the Network category by 1.

Step 1315 continues to a step 1375 of outputting a related component category as Network and the risk count for the Network category.

Returning to step 1310, if the method 1300 determines at step 1310 that the scanned component category is not network related, the method 1300 proceeds to a step 1320 of determining whether the scanned component category is platform or operating system related. For example, the scanned component category is considered to be platform or operating system related if Category is ‘AIX’, ‘Amazon Linux’, ‘Backdoors and trojan horses’, ‘CentOS’, ‘Debian’, ‘Fedora’, ‘Forensics’, ‘Hardware’, ‘HP-UX’, ‘Local’, ‘OVAL’, ‘RedHat’, ‘SMB/NETBIOS’, ‘Solaris’, ‘SUSE’, ‘Ubuntu’, ‘Vmware’, ‘Web server’, ‘Windows’ or ‘X-Window’. If affirmative, the method 1300 proceeds to a step 1325 of determining the related risk category as a Platform category and incrementing the risk count for the Platform category by 1. Step 1325 continues to step 1375 of outputting a related component category as Platform and the risk count for the Platform category.

Otherwise, if the method 1300 determines at step 1320 that the scanned component category is not platform or operating system related, the method 1300 proceeds to a step 1330 of determining whether the scanned component category is browser, mail server or news server related. For example, the scanned component category is considered browser, mail server or news server related if Category is ‘Internet Explorer’, ‘Mail services’ or ‘News Server’. If affirmative, the method 1300 proceeds to a step 1335 of determining the related risk category as an Internet category and incrementing the risk count for the Internet category by 1. Step 1335 continues to step 1375 of outputting a related component category as Internet and the risk count for the Internet category.

If the method 1300 determines at step 1330 that the scanned component category is not browser, mail server or news server related, the method 1300 proceeds to a step 1340 of determining whether the scanned component category is application related. For example, the scanned component category is considered application related if Category is ‘Internet Explorer’, ‘CGI’, ‘E-Commerce’, ‘Office Application’, ‘RPC’ or ‘Web Application’. If affirmative, the method 1300 proceeds to a step 1345 of determining the related risk category as an Application category and incrementing the risk count for the Application category by 1. Step 1345 continues to step 1375 of outputting a related component category as Application and the risk count for the Application category.

If the method 1300 determines at step 1340 that the scanned component category is not application related, the method 1300 proceeds to a step 1350 of determining whether the scanned component category is data related. For example, the scanned component category is considered data related if Category is ‘Database’, ‘File Transfer Protocol’, ‘Information gathering’, ‘OEL’ or ‘Oracle VM Server’. If affirmative, the method 1300 proceeds to a step 1355 of determining the related risk category as a Data category and incrementing the risk count for the Data category by 1. Step 1355 continues to step 1375 of outputting a related component risk category as Data and the risk count for the Data category.

If the method 1300 determines at step 1350 that the scanned component category is not data related, the method 1300 proceeds to a step 1360 of determining whether the scanned component category is security policy related. For example, the scanned component category is considered security policy related if category is ‘Security Policy’, e.g. the vulnerability has a vulnerability identifier (QID) that detects vulnerabilities or gather information about security policies. Such vulnerabilities are generally informational types of checks that detect the presence of anti-virus or various other settings that could be pushed with a windows group policy. If affirmative, the method 1300 proceeds to a step 1365 of determining the related risk category as a Security Policy category and incrementing the risk count for the Security Policy category by 1. Step 1365 continues to step 1375 of outputting a related component category as Security Policy and the risk count for the Security Policy category.

Otherwise, if the method 1300 determines at step 1360 that the scanned component category is not security policy related, the method 1300 proceeds to a step 1370 of determining that the scanned component category is Other and incrementing the risk count for the Other category by 1. Step 1370 continues to step 1375 of outputting a related component category as Other and the risk count for the Other category.

In some implementations, the method 1300 may also increment the risk rate count corresponding to the determined risk rate for the determined category. As such, each category may be associated with a count for each risk rate from the plurality of categorized risk rates, e.g. VHR, HR, MR, LR rates, for example as shown in Table 7. The method 200 may select a risk rate count for the highest risk rate for the category for determining the security score of the third party provider.

The method 1300 concludes on completion of step 1375.

FIG. 14 shows a flowchart of method 1400 of determining a security score of a third party provider in accordance with one implementation of the present invention. The method 1400 is executed on the processor 105 of the server 370 under control of instructions stored in memory 106. The method 1400 effectively calculates the vendor security score based on the assessed risks.

The method 1400 commences with a step 1405 of receiving very high risk (VHR), high risk (HR), moderate risk (MR) and low risk (LR) rate counts for each scan result of the vendor for each related client separately. The method 1400 proceeds from step 1405 to a step 1410 of determining a number of each risk in the internal vulnerability report prepared by the third-party provider for the client as XVHR, XHR, XMR, XLR and total risk as X. Step 1410 can be implemented as shown in FIGS. 10-13.

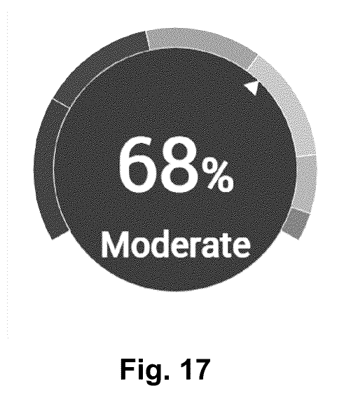

Method 1400 effectively receives Risk Rate counts (the total number of each Very High Risk, High Risk, Medium Risk and Low) for each scan result of the vendor for each related client separately and calculates the Security Score for the client which subsequently shown as a Security Score report. Examples of the Security Score Report are shown in FIGS. 16 and 17.

Step 1410 continues to steps 1415 to 1490 of determining the security score of the third party provider conditional upon the determined number of risks for each risk rate. Specifically, the method 1400 determines at step 1415 whether the number of very high risks is above zero. If affirmative, the method 1400 proceeds to a step 1420 of determining whether the number of all other risks, i.e. high risks, moderate risks and low risks, is equal to zero. If the number of all other risks, i.e. high risks, moderate risks and low risks, is equal to zero, the method 1400 determines the security score at a step 1425 using Equation 4 below:

$$SS = 100 - ( VHRR + [ ( XVHR / N ) * VHRW ] \qquad ( 4 )$$

Step 1425 continues to a step 1430 of determining security score attributes based on the determined security score. The security score attributes include a display name, rendered colour, pointer position for the security score. Implementation detail of step 1430 are discussed below with reference to FIG. 15. The method 1400 concludes on completion of step 1430.

Otherwise, if the method 1400 determines that the number the high risks, moderate risks or low risks is not equal to zero, the method 1400 determine the security score at a step 1435 using Equation 5 below.

$$SS = [ 100 - ( VHRR + [ ( XVHR / N ) * VHRW ] ) ] - [ \text{} 1 / 2 ( Max HRRS - ( 100 - [ HRR + ( ( XHR / N ) * HRW ) ] ) ) + 1 / 3 ( Max MRRS - ( 100 - [ MRR + ( ( XMR / N ) * MRW ) ] ) ) + 1 / 4 ( Max LRRS - ( 100 - [ LRR + ( ( XLR / N ) * LRW ) ] ) ) ] \qquad ( 5 )$$

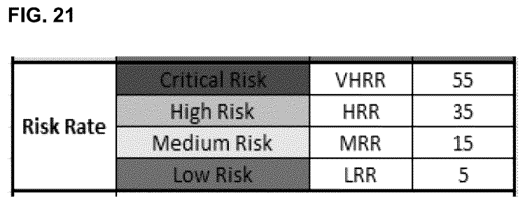

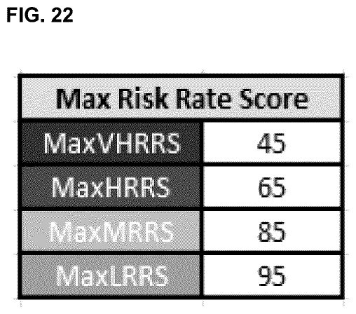

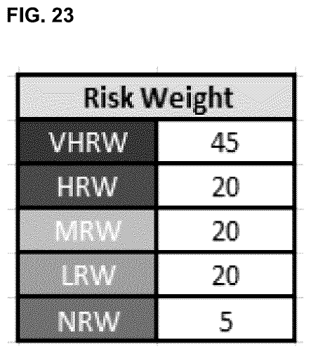

For the purposes of the present disclosure, the following notations are adopted:
N is the total number of scanned/reviewed components;
X is the total number of risks;
XVHR is the total number of the very high risks, XHR is the total number of high risks, XMR is the total number of medium risks, XLR is the total number of low risks;
VHRR, HRR, MRR, LRR are initial scores for very high risks, high risks, moderate risks and low risks respectively. Example initial scores are shown in FIG. 21;
Max VHRRS, MaxHRRS, MaxMRRS and MaxLRRS are maximum risks rate scores for very high risks, high risks, moderate risks and low risks respectively. Example maximum risk rate scores are shown in FIG. 22; and
VHRW, HRW, MRW and LRW are risk weights for very high risks, high risks, moderate risks and low risks respectively. Example risk weights for different risk are shown in FIG. 23.

Step 1435 continues to a step 1430 of determining security score attributes based on the determined security score.

Returning to step 1415, if the method 1400 determines at step 1415 that the number of very high risks does not exceed 0, the method 1400 continues to a step 1440 of determining if the number of very high risks is 0 and the number of high risks exceeds 0.

If affirmative, the method 1400 proceeds to a step 1445 of determining whether the number of all other risks, i.e. moderate risks and low risks, is equal to zero. If the number of moderate risks and low risks is equal to zero, the method 1400 determines the security score at a step 1450 using Equation 6 below:

$$SS = 100 - [ HRR + ( ( XHR / N ) * HRW ) ] \qquad ( 6 )$$

Step 1450 continues to a step 1430 of determining security score attributes based on the determined security score. Otherwise, if the method 1400 determines that the number of moderate risks or low risks is not equal to zero, the method 1400 determine the security score at a step 1455 using Equation 7 below.

$$SS = [ 100 - [ HRR + ( ( XHR / N ) * HRW ) ] ] - [ \text{} 1 / 2 ( Max MRRS - [ 100 - [ MRR + ( ( XMR / N ) * MRW ) ] ] ) + 1 / 3 ( Max LRRS - ( 100 - [ LRR + ( ( XLR / N ) * LRW ) ] ) ) ] \qquad ( 7 )$$

Step 1455 continues to a step 1430 of determining security score attributes based on the determined security score.

Returning to step 1440, if the method 1400 determines at step 1440 that the number of high risks does not exceed 0, the method 1400 continues to a step 1460 of determining if the number of very high risks is 0, the number of high risks is 0 and the number of moderate risks exceeds 0. If affirmative, the method 1400 proceeds to a step 1465 of determining whether the number of low risks is equal to zero. If the number of low risks is equal to zero, the method 1400 determines the security score at a step 1470 using Equation 8 below:

$$SS = 100 - [ MRR + ( ( XMR / N ) * MRW ) ] \qquad ( 8 )$$

Step 1470 continues to a step 1430 of determining security score attributes based on the determined security score. Otherwise, if the method 1400 determines that the number of low risks is not equal to zero, the method 1400 determine the security score at a step 1475 using Equation 9 below.

$$SS = [ 100 - [ MRR + ( ( XMR / N ) * MRW ) ] ] - [ \text{} 1 / 2 ( Max LRRS - ( 100 - [ LRR + ( ( XLR / N ) * LRW ) ] ) ) ] \qquad ( 9 )$$

Step 1475 continues to step 1430 of determining security score attributes based on the determined security score.

Returning to step 1460, if the method 1400 determines at step 1460 that the number of moderate risks does not exceed 0, the method 1400 continues to a step 1480 of determining if the number of very high risks is 0, the number of high risks is 0, the number of moderate risks is 0 and the number of low risks exceeds 0. If affirmative, the method 1400 determines the security score at step 1485 using Equation 10 below. Otherwise, the method 1400 determines the security score at step 1490 as 98 or another number exceeding between 95 and 100. Steps 1485 and 1490 continue to step 1430.

$$SS = 100 - [ LRR + ( ( XLR / N ) * LRW ) ] \qquad ( 10 )$$

The method 1400 concludes of completion of step 1430. A person skilled in the art would appreciate that different weights, initial score and thresholds can be used for determining the security score.

FIG. 15 shows a flowchart of method 1500 of determining security score attributes based on the determined security score in accordance with one implementation of the present disclosure. The method 1500 is executed on a processor 105 of the server 370 under control of instructions stored in memory 106. The method 1500 effectively determines the graphical color and name of the determined security score.

The method 1500 commences with a step 1505 of receiving a security score. The method 1200 proceeds from step 1505 to a step 1510 of determining whether the security score is equal to or higher than 0 and lower than 25. If affirmative, the method 1500 proceeds to a step 1515 of determining the security score name as ‘Severe’, the security score color as ‘Dark Red’ and the security score pointer position. For example, as shown in FIGS. 16 and 17, the pointer position can be determined for the Security score as a percentage in a wheel from 0 to 100 based on the security score.

Returning to step 1510, if the method 1500 determines at step 1510 that the security score is not equal to or higher than 0 or lower than 25, the method 1500 proceeds to a step 1520 of determining whether the security score is equal to or higher than 25 and lower than 45. If affirmative, the method 1500 proceeds to a step 1525 of determining the security score name as ‘High’, the security score color as ‘Red’ and the security score pointer position as a percentage between 0 to 100 for the determined security score.

Otherwise, if the method 1500 determines at step 1520 that the security score is not equal to or higher than 25 or lower than 45, the method 1500 proceeds to a step 1530 of determining whether the security score is equal to or higher than 45 and lower than 65. If affirmative, the method 1500 proceeds to a step 1535 of determining the security score name as ‘Elevated’, the security score color as ‘Brown’ and the security score pointer position as a percentage between 0 to 100 for the determined security score. For example, as shown in FIG. 16 a security score pointer of 45% may be determined for the security score of 45.

If the method 1500 determines at step 1530 that the security score is not equal to or higher than 45 or lower than 65, the method 1500 proceeds to a step 1540 of determining whether the security score is equal to or higher than 65 and lower than 85. If affirmative, the method 1500 proceeds to a step 1545 of determining the security score name as ‘Moderate’, the security score color as ‘Amber’ and the security score pointer position as a percentage between 0 to 100 for the determined security score. For example, as shown in FIG. 17, the pointer position, e.g. 68%, can be determined for “Moderate” security score of 68.

If the method 1500 determines at step 1540 that the security score is not equal to or higher than 65 or lower than 85, the method 1500 proceeds to a step 1550 of determining whether the security score is equal to or higher than 85 and lower than 95. If affirmative, the method 1500 proceeds to a step 1555 of determining the security score name as ‘Low’, the security score color as ‘Light Blue’ and the security score pointer position as a percentage between 0 to 100 for the determined security score. Otherwise, the method 1500 determines at a step 1560 that the security score name is ‘Perfect’, the security score color as ‘Blue’ and the security score pointer position as a percentage between 0 to 100 for the determined security score.

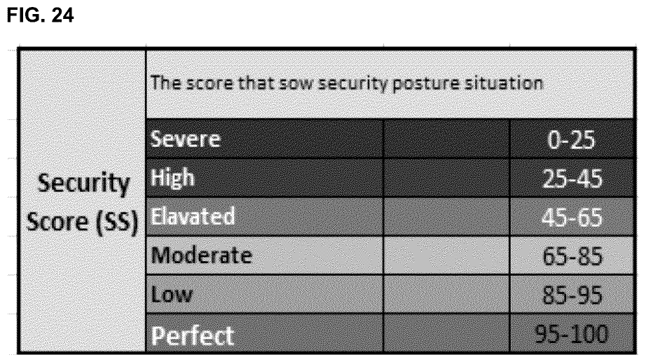

A person skilled in the art would appreciate that different thresholds for determining the security score attributes can be used. Additionally, different combinations of security score names, colours and pointer positions can also be used. Example thresholds are shown in FIG. 24.

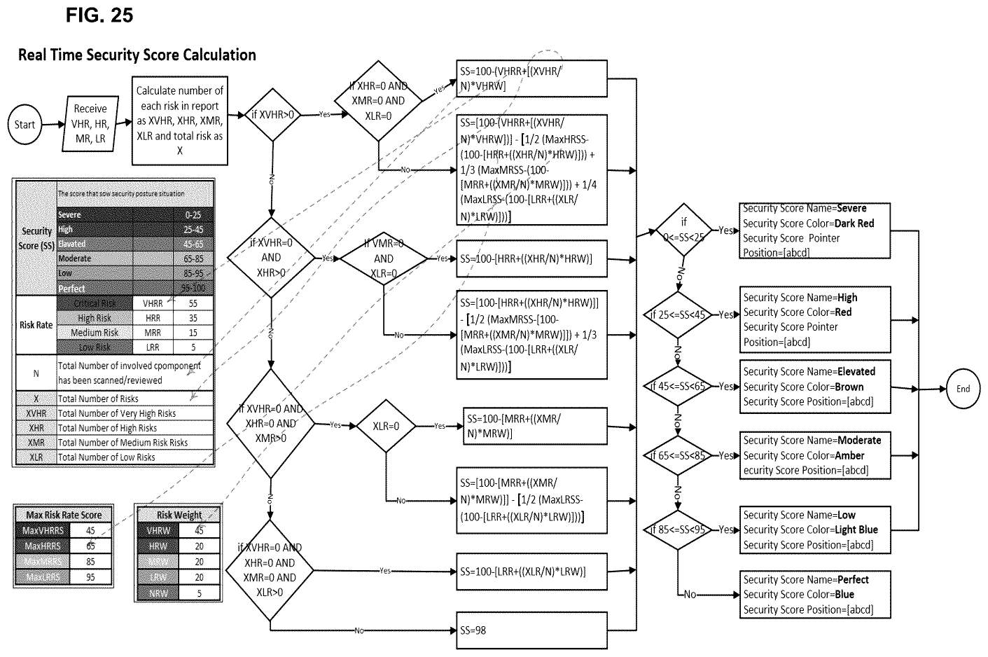

Steps 1515, 1525, 1535, 1545, 1555 and 1560 proceed to a step 1570 of outputting the determined security score attributes, for example, for display on a display device of the client device 320. The method 1500 concludes of completion of step 1570. An example of a security score calculation is shown in FIG. 25.

In some implementations, the vendor application 420 is additionally or alternatively configured to track response to questionnaires, store the response from the vendor to the questionnaires by updating a profile of the vendor. For example, the profile can be updated by recording answers of the vendor for each question. Additionally or alternatively, the profile can be learned from answers of the vendor, i.e. answers to questions different to the answered question can be devised from recorded answers.

The profile of the vendor can be used later to fill in subsequent questionnaires from the same client or another client. The approach of updating the vendor profile is particularly advantageous for providing the Intelligent Classic VRM solution 720.

FIG. 9 shows an extension 900 of the disclosure to fourth, fifth, sixth, seventh, eighth etc. party providers. The fourth, fifth, sixth, seventh, eighth etc. party providers are also considered third-party providers for the purposes of the present disclosure. In particular, in accordance with one implementation of the present disclosure, information security risks of a particular client can be graphically represented as shown in FIG. 9. For example, vendor security risks can be highlighted for all third party providers based on the security scores specific for the client determined for each of the third-party providers 910, 920, 930, 940, 950, 960, 970 and 980. The arrangement 900 advantageously allows the client to automatically control, e.g. assess and remediate, weaknesses in data security.

FIG. 9 shows first degree third-party providers 910 and 920, i.e. third-party providers providing services directly to the client, as third-party vendors. FIG. 9 also shows second degree third-party providers 930 and 940 as fourth-party vendors, and third-degree third-party providers as fifth-party vendors 950, fourth degree third-party providers as sixth-party vendors 960 and so on. An internal vulnerability scan may be run hourly, daily, weekly, monthly, quarterly or annually by the third-party vendor 910 while the scan is scheduled by the vendor 910 for any of the clients based on internal security policy and standards. In some implementations, the vulnerability scan schedule is hourly, daily, weekly, monthly, quarterly or annually based. Alternatively, the vulnerability scan is a mixture of hourly, daily, weekly, monthly, quarterly or annually based schedules depending on the scope and type of the scans.

When the internal vulnerability scan is finished, the result of the scan is produced and stored at a destination address to which the DataCollector application has an access. For example, the CSV file is exported to the destination address and the DataCollector application has an access to that destination address. In some implementations, the DataCollector 430 checks the destination. When the DataCollector 430 determines that a new file is added to the destination, the DataCollector 430 runs a process to collect the required data from the new CSV file and send the collected data to the Central application 440 to analyse and produce the Risks, Security Score and related Real-Time report for clients related to that scan result.

In some implementations, the Vendor-Client Real-Time license connection is one-way from Vendor to Client, and the client does not have any access to the vendor. Neither does the client need to send any request directly to the vendor so that to protect vendor's security and privacy. The vendor, however, may also use a Client application where the vendor is a client of a fourth-party vendor. As such, the vendor can be notified if the fourth-party vendor is at risk. The same is applicable for 5th, 6th and . . . 10th party vendors. For example, as shown in FIG. 9, the vendor 915 is a client of the vendor 940 (fourth-party vendor). As such, the vendor 915 will be notified of security risks associated with the fourth-party vendor 940.

FIG. 8 shows an overview of the Intelligent Classic VRM solution 720 in accordance with another arrangement of the present disclosure. The Intelligent Classic VRM solution 720 provides a tailored questionnaire generation process.

For example, in the Intelligent Classic VRM solution 720, the client application 410 is configured to automatically generate and send 810 a questionnaire to the third party provider based on analysis of the client workflow by determining sensitive security aspects for the client. The vendor application 420 is configured to receive the questionnaire and automatically generate responses 820 to the questions based on the profile of the vendor. The generated responses at 820 are automatically analysed at 830 to determine whether the profile of the vendor needs updating.

At 840, the vendor application is configured to notify a vendor representative that the questionnaire needs to be reviewed. The vendor application is further configured to allow the vendor representative to review, modify and/or approve the answers to the questionnaire and send the answers of the vendor to the client application 410. The client application 410 is configured to allow 845 the client representative to review the answers of the vendor and request further information prompting the vendor application 420 to respond for the request for further information.

The client application 410 is configured conduct a risk assessment 850 and perform risk remediation 855 using approaches known in the art. The client application 410 is also configured to automatically generate reports 860 and review 870 the generated reports.

According to one implementation of the Intelligent Classic VRM solution 720, the Client application comprises instructions to generate a tailored questionnaire for each vendor. The generated tailored questionnaire is a selection of questions from the master questionnaire. The master questionnaire typically includes standard questions and format generally adopted in the art. In some implementations, the master questionnaire includes specific questions regarding different aspects of security, e.g. different sections) such as questions regarding an Information Security Policies section, Organisation of Information Security section, Asset management section, Data Security and Encryption section, Human resources Security section, Physical and Environmental Security section, Communication and Operations Management section, Identity and Asset management section, Information Security Incident Management section and a Generic Questions section. For each section, the master questionnaire includes a plurality of questions relevant to the section, an answer to the question, importance level of each question, indication whether evidence is required, type of required evidence. Each question is to be answered to each type of vendor service technology used by the vendor, e.g. SaaS, PaaS, IaaS etc., as well as regarding compliance with a particular framework, e.g. PCI-DSS, ISO27001, SOC2, IRAP etc. Other fields can also be included.

To generate a tailored questionnaire for a vendor, the Client application reads a vendor profile and, based on the information in the vendor profile, e.g. service type, vendor importance level and etc., chooses appropriate questions for the vendor. Additionally, each Client application may be configured to add customised questions for all or some selected vendors depending on preferences of a particular client.

In some implementations, each question in the master questionnaire has an attribute that the Client application can check to determine whether the question matches the vendor profile for a specific client account. Accordingly, to select questions from the master questionnaire, the Client application determines whether an attribute of each question in the master questionnaire matches the vendor profile for a specific client account. If the questions match the vendor profile, the questions are included in the tailored questionnaire. Example fields in the master questionnaire are listed below:

### Question ID:

Value Options: Unique code for the question in the master questionnaire.
Description: Each question in the master questionnaire has a unique code. The unique code may be from the master questionnaire that is added by an administrator. The unique code is available for all clients. Alternatively, the unique code can be assigned to a customised question that is added by each client administrator user. A unique code created for a customised question is available only for the client who created the customised questions and not other clients. If the administrator user wants to edit some questions in the master questionnaire (or the client administrator wants to edit their customised questions), a new question with the new unique code is created instead of editing the current question to ensure consistency so that the change does not affect previously answered questions.
Status for Customised Added Questions: As described above.

### Question Type (Risk_Type):

Value Options: Platform, Data, Network, Security Policy, Internet, Others
Description: When the client application sends a questionnaire to a vendor and receives their response, and after review by the client user, the client application determines that there is a risk for that question, the client application identifies the risk type from the question type automatically.
Status for Customised Added Questions: When a client has added a new customised question, the client application asks the client to choose one of the above value options for that question.

### Answer Option:

Value Options: Yes, No, N/A (Not Applicable)
Description: Some questions have Yes/No answer option, and some questions have Yes/No/NA option. For instance, “Does the organisation provide appropriate awareness education and training for all employees?” the answer option is Yes/No (the N/A is not available here). But for a questions “Does the product have data masking and tokenisation capabilities?” the answer option is Yes/No/NA
Status for Customised Added Questions: For new questions added by the client, the answer option is Yes/No/NA by default, and the client doesn't have the option to change it.

### Importance Level:

Value Options: 1, 2, 3
Description: When a client is submitting a questionnaire for a vendor, SBB-Client asks the user what is the importance level for this vendor. Importance Level-1 is the most important vendor, which contains more questions in the questionnaire and Importance Level-3 is the less important vendor and contains fewer questions in the questionnaire. In the master questionnaire, each question is marked as 1, 2, 3 (this question will apply to all Importance Levels) or 1, 2 (This question applied just to the Importance Level 1 & 2) or 1 (this question applies just to Importance Level-1)
Status for Customised Added Questions: All the Importance Levels of customised questions that will be added by clients is 1, 2, 3 by default, and the client can't change them.

### Evidence Required (Evidence_Required)

Value Options: Y (Yes), N (No), O (Optional)
Description: Some questions might need to provide evidence to support the answers. If the evidence field of question is “Y”, it means the evidence is mandatory to be added to the question; if “N”, no evidence requires; if “O”, evidence is optional to be provided. If evidence is mandatory (Y), the vendor can not submit the answered questionnaire without uploading the evidence file.
Status for Customised Added Questions: The default value of evidence Required for customised questions is “O” (Optional) and cannot be changed by the client.

### Type of Evidence (Evidence_Type)

Value Options: In some implementations, there are 24 different evidence types, for example:
   1: Valid ISO 27001 Certificate
   2: Valid ISOC2 Certificate
   3: Valid PCI-DSS Certificate
   4-10: Reserved
   11: Any relevant evidence
   12: Front page of relevant policy
   13: Table of contents of relevant policy
   14: Change history page of relevant policy
   15: Overview of Security Team
   16: Information about how data is segregated and Encrypted
   17: Information about how data is Encrypted
   18: Organisation Security Roles and Responsibilities information
   19: Any evidence of employees security training
   20: Screen shot of the related section of document which mentions the requirement
   21: Name of the countries that store the data
   22: Details of Incident
   23: Information about what access is required
   24: N/A
Description: When the question Evidence Required is “Y” or “O”, then the question will provide what type of evidence is needed to guide the vendor to provide it.
Status for Customised Added Questions: The default value for any customised added question is “11: Any related evidence” and the client cannot change it.

### Type of Vendor Service Technology (Service_Model):

Value Options: SaaS, PaaS, IaaS, Application, Service, Others
Description: When a client sends a questionnaire to a vendor, the Client application reads the vendor profile to determine the vendor type (e.g. is a SaaS application). The Client application subsequently select the questions where the service_model field for the vendor is SaaS. For instance, if the vendor type is IaaS (Infrastructure as a Service), no questions about infrastructure will be sent to the vendor as that will be responsibility of the client.
Status for Customised Added Questions: When a client adds customised questions, all the values of service_model will be added to the question by default, and the client cannot make changes.

### Framework (Compliance):

Value Options: PCI-DSS, ISO27001, SOC2, IRAP
Description: At the very section of the questionnaire, there are questions about any certificate that the vendor might have (for example, the certificates identified in Value Options). If the vendor answers is Yes to any of the framework compliance questions and attach the corresponding certificate, all the related questions to that certificate will be automatically answered Yes by the Intelligent Classic VRM. As such, the vendor would not need to manually answer such questions. The way that it works for each question, if the value is Yes for a particular framework compliance question, e.g. PCI-DSS, ISO 27001, IRAP, SOC2, and the certificate is attached, the Intelligent Classic VRM application automatically fills in Yes to other certification questions related to that particular framework compliance question.
Status for Customised Added Questions: The default value of the certificate for newly added questions by the client is “N”.

When a vendor answers a received questionnaire from a client, the Intelligent Classic VRM allows saving the answered questionnaire into an Auto-Response feature of the Intelligent Classic VRM. Accordingly, an answer will be saved for each unique question ID. When the next time vendor receives another questionnaire from the same or another client, the Intelligent Classic VRM allows the vendor to respond with the Auto-Response. The Auto-Response feature will check the new questionnaire question IDs, and if the same ID is found in the Auto-Response library, the Auto-Response will answer with the saved answer in the library. Where answers do not exist in the Auto-Response, the vendor user will answer such questions manually and can choose to save them to the Auto-Response. Accordingly, after answering a few questionnaires, the Auto Response feature will have answers to substantially the entire questionnaire. As such, questions could be answered automatically instantly after receiving the questionnaire thus reducing the need for the vendor to respond to such questions one by one again and again.

### INDUSTRIAL APPLICABILITY

The arrangements described are applicable to the computer and data processing industries and particularly for the provision of information security and determining and/or controlling security of data available to a third-party provider.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of controlling security of data belonging to a client and available to a third-party provider, the method comprising:
receiving vulnerability scan data;
determining a plurality of vulnerability metrics for the data of the client at the third-party provider using the vulnerability scan data, wherein the plurality of vulnerability metrics are based on where the data belonging to the client is stored at the third-party provider;
determining a security score for the third-party provider based on the plurality of vulnerability metrics and a risk profile of the client; and
causing a display device to display the security score determined for the third-party provider to control security of the data belonging to the client and available to the third-party provider.

2. A method according to claim 1, wherein receiving the vulnerability scan data comprises parsing an internal vulnerability scan report generated by the third-party provider.

3. A method according to claim 2, wherein the internal vulnerability scan is performed for storage locations identified by the third-party provider as storing data belonging to the client.

4. A method according to claim 2, wherein the plurality of vulnerability metrics is selected based on where the data belonging to the client is stored at the third-party provider.

5. A method according to claim 2, wherein receiving the vulnerability scan data comprises accessing a container associated with the third-party provider, the container comprising an indication of a location where internal vulnerability scan data related to the data of the client is stored.

6. A method according to claim 5, wherein the container is installed inside or outside a network of the third-party provider.

7. A method according to claim 1, wherein the vulnerability scan data identifies the third-party provider.

8. A method according to claim 7, further comprising:
determining at least one first client of the third-party provider identified in the vulnerability scan data, wherein the plurality of vulnerability metrics are determined for the at least one first client.

9. A method according to claim 8, further comprising:
determining at least one further client of the third-party provider identified in the vulnerability scan data;
determining a plurality of vulnerability metrics for the data of the at least one further client at the third-party provider; and
determining a security score for third-party provider with respect to the at least one further client based on the plurality of vulnerability metrics and a risk profile associated with the at least one further client, wherein the security score for the third-party provider with respect to the at least one further client is different to the security score for the third-party provider with respect to the at least one first client.

10. A method according to claim 1, wherein determining a security score for the third-party provider comprises:
determining a value representing a number of risks in each of a plurality of risk categories based on the risk profile associated with the client and the plurality of vulnerability metrics; and
determining the security score for the third-party provider based on the determined values, wherein each value represents a number of risks for a risk category in the plurality of risk categories.

11. A method according to claim 10, further comprising:
determining a graphical representation of the security score based on a threshold to display on the display device.

12. A method according to claim 1, further comprising determining a plurality of third-party providers of the client by analysing internal data of the client and storing a correspondence between the client and the plurality of third-party providers in a database.

13. A system for controlling security of data available to a third-party provider, the system comprising:
a third-party provider module comprising a third-party provider processor and third-party provider memory storing instructions which when executed by the third-party provider processor cause the third-party provider processor to:
provide an access to a location storing vulnerability scan data for a conducted internal vulnerability scan, the vulnerability scan data comprising a plurality of vulnerability metrics for the data of the client at the third-party provider, wherein the vulnerability scan data is based on where the data belonging to the client is stored at the third-party provider;
a third-party risk assessment module communicatively coupled with the third-party module, the third-party risk assessment module comprising a processor and memory storing instructions which when executed by the processor cause the processor to:
access the location storing the vulnerability scan data associated with the third-party provider;
determining at least one client to which the vulnerability scan data pertains by accessing a database storing a correspondence between the at least one client and the third-party provider;
determine a security score for the third-party provider based on the plurality of vulnerability metrics and a risk profile associated with the at least one client, wherein the plurality of vulnerability metrics is determined from the vulnerability scan data; and
cause a display device to display the security score determined for the third-party provider.

14. A system according to claim 13, wherein determining a security score for the third-party provider comprises:
determining a value representing a number of risks in each of a plurality of risk categories based on the risk profile associated with the client for the third-party provider and the plurality of vulnerability metrics;
determining the security score for the third-party provider based on the determined values, wherein each value represents a number of risks for a risk category in the plurality of risk categories;
determining a graphical representation of the security score based on a threshold to display of the display device.

15. A system according to claim 13, further comprising a client module, the client module comprising a client processor and client memory storing instructions which when executed by the client processor cause the client processor to determine a third-party provider involved with data of a client.

16. A computer readable storage medium for determining security of data belonging to a client and available to a third-party provider, the computer readable storage medium comprises computer readable instructions stored therein, the computer readable instructions being executable by a processor to cause the processor to:
receive internal vulnerability scan data for at least a portion of infrastructure controlled by the third-party provider;
determine a plurality of vulnerability metrics for the third-party provider from the received internal vulnerability scan data; and
determine security of the data belonging to the client and available to the third-party provider based on the plurality of vulnerability metrics and a risk profile of the client.

17. A computer readable storage medium according to claim 16, wherein a value of at least one of the plurality of vulnerability metrics for the data for the client differs from a value of a corresponding at least one of the plurality of vulnerability metrics for the data for a further client; and
wherein a security score for the third-party provider with respect to the further client is different to the security score for the third-party provider with respect to the client.

18. A computer readable storage medium according to claim 16, wherein receiving vulnerability scan data comprises parsing an internal vulnerability scan report prepared by the third-party provider.

19. A computer readable storage medium according to claim 16, further comprising instructions for determining a security score for the third-party provider to cause the processor to:
determine a value representing a number of risks in each of a plurality of risk categories based on the risk profile associated with the client for the third-party provider and the plurality of vulnerability metrics;
determining the security score for the third-party provider based on the determined values;
determining a graphical representation of the security score based on a threshold to display of the display device.
